(19) United States
(12) Patent Application Publication
(10) Pub. No.: US 2026/0209053 A1
(43) Pub. Date: Jul. 23, 2026

(54) Functionalized Colloidal Silica and Methods of Production

(71) Applicant: W.R. Grace & Co.-CONN., Columbia, MD (US)

(72) Inventors: FENG GU, ELLICOTT CITY, MD (US); DAVID M. CHAPMAN, ELLICOTT CITY, MD (US)

(21) Appl. No.: 19/134,494

(22) PCT Filed: Dec. 5, 2023
(86) PCT No.: PCT/US2023/082582

§ 371 Date: May 30, 2025

Related U.S. Application Data
(60) Provisional application No. 63/430,618, filed on Dec. 6, 2022.

(51) Int. Cl. C01B 33/14

(52) U.S. Cl. CPC C01B 33/14; C01P 2004/64; C01P 2006/12

(57) ABSTRACT

The present disclosure is directed to compositions that include water and a functionalized colloidal silica, where the functionalized colloidal silica includes silica particles (where each silica particle includes a surface) as well as a structural unit according to Formula I and/or a structural unit according to Formula II

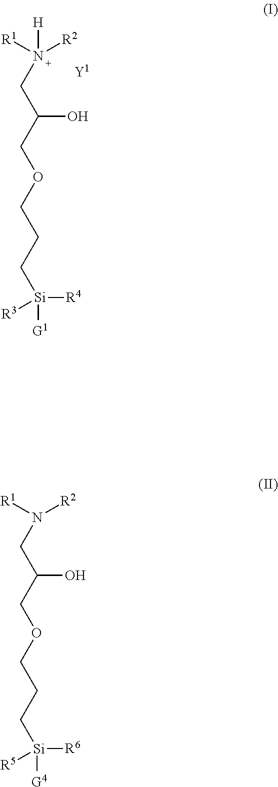

The present disclosure also is directed to methods of making compositions of the present technology.

### CROSS-REFERENCE TO RELATED APPLICATIONS

This application claims the benefit of priority to U.S. Provisional Patent Application No. 63/430,618, filed on Dec. 6, 2022, the contents of which are incorporated herein by reference in their entirety.

### BACKGROUND

The present technology relates generally to functionalized colloidal silica as well as methods useful for synthesizing such functionalized colloidal silica, including compositions that are stable to aging for 24 hours or longer at temperature of 80° C. when the composition includes a salt solution at an ionic strength of 0.5 to 3.0.

### SUMMARY

In an aspect, the present technology provides a composition that includes water and a functionalized colloidal silica. The functionalized colloidal silica includes silica particles (where each silica particle includes a surface) and a structural unit according to Formula I and/or a structural unit according to Formula II

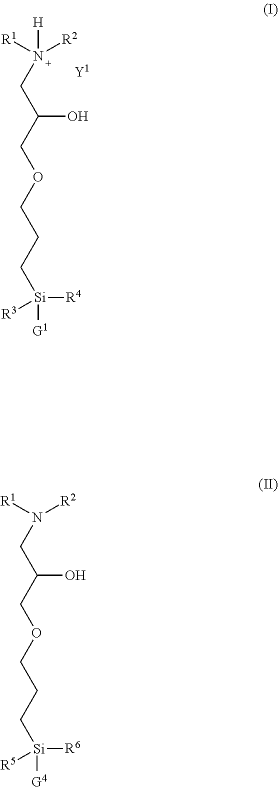

where
R¹ is H, unsubstituted alkyl, a hydroxyl-substituted alkyl, an alkoxy-substituted alkyl, a hydroxyl-substituted cycloalkyl, aryl, or heteroaryl;
R² is a hydroxyl-substituted alkyl, an alkoxy-substituted alkyl, or a hydroxyl-substituted cycloalkyl;
or R¹ and R² taken together are a hydroxyl-substituted C₄-C₆ alkylene group;
R³ is hydroxyl, alkoxy, aryloxy, or G²;
R⁴ is hydroxyl, alkoxy, aryloxy, or G³;
R⁵ is hydroxyl, alkoxy, aryloxy, or G⁵;
R⁶ is hydroxyl, alkoxy, aryloxy, or G⁶;
G¹, G², G³, G⁴, G⁵, and G⁶ are each independently an oxygen atom of the surface of the silica particle, where G¹, G², G³, G⁴, G⁵, and G⁶ are not the same oxygen atom; and
Y¹ is an anion.

In another aspect, the present technology provides a method of making a functionalized colloidal silica (for example, a method of making a composition of any embodiment herein). The method includes contacting a colloidal silica with a silane according to Formula IV to yield the functionalized colloidal silica

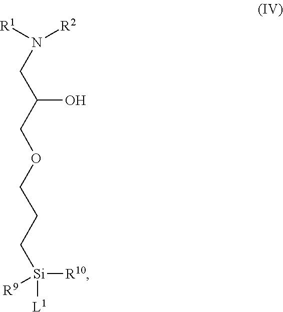

wherein
R¹ is H, unsubstituted alkyl, a hydroxyl-substituted alkyl, an alkoxy-substituted alkyl, a hydroxyl-substituted cycloalkyl, aryl, or heteroaryl;
R² is a hydroxyl-substituted alkyl, an alkoxy-substituted alkyl, or a hydroxyl-substituted cycoalkyl;
or R¹ and R² taken together are a hydroxyl-substituted C₄-C₆ alkylene group;
R⁹ is hydroxyl, alkoxy, or aryloxy;
R¹⁰ is hydroxyl, alkoxy, or aryloxy; and
L¹ is alkoxy or aryloxy.

In a further aspect, the present technology provides a functionalized silica prepared according to a method of any embodiment described herein.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF THE DRAWINGS

FIG. 1 provides ¹³C-NMR spectroscopic results of a test performed on a composition of the present technology, as described in the working examples.

FIG. 2 depicts the zeta titration results of LUDOX HS-40, according to the working examples

FIG. 3 depicts the zeta titration results of diethanolamine-functionalized LUDOX HS-40, according to the working examples.

FIG. 4 depicts a comparison of particle surface zeta potentials of functionalized colloidal silica of Examples 1-6 in accordance with the present technology, according to the working examples.

FIG. 5 compares the zeta potential profile of unmodified LUDOX AM with Example 9 (Example 9 being a composition of the present technology), according to the working examples.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein and in the appended claims, singular articles such as “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term—for example, “about 10 wt. %” would be understood to mean “9 wt. % to 11 wt. %.” It is to be understood that when “about” precedes a term, the term is to be construed as disclosing “about” the term as well as the term without modification by “about”—for example, “about 10 wt. %” discloses “9 wt. % to 11 wt. %” as well as disclosing “10 wt. %.”

The phrase “and/or” as used in the present disclosure will be understood to mean any one of the recited members individually or a combination of any two or more thereof—for example, “A, B, and/or C” would mean “A or B or C; A and B; A and C; B and C; or the combination of A, B, and C.”

Generally, reference to a certain element such as hydrogen or H is meant to include all isotopes of that element. For example, if an R group is defined to include hydrogen or H, it also includes deuterium and tritium. Compounds comprising radioisotopes such as tritium, C¹⁴, P³² and S³⁵ are thus within the scope of the present technology. Procedures for inserting such labels into the compounds of the present technology will be readily apparent to those skilled in the art based on the disclosure herein.

In general, “substituted” refers to an organic group as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group is substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, aryloxy, aralkyloxy, heterocyclyl, heterocyclylalkyl, heterocyclyloxy, and heterocyclylalkoxy groups; carbonyls (oxo); carboxylates; esters; urethanes; oximes; hydroxylamines; alkoxyamines; aralkoxyamines; thiols; sulfides; sulfoxides; sulfones; sulfonyls; pentafluorosulfanyl (i.e., SF₅), sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; and nitriles (i.e., CN).

Substituted ring groups such as substituted cycloalkyl, aryl, heterocyclyl and heteroaryl groups also include rings and ring systems in which a bond to a hydrogen atom is replaced with a bond to a carbon atom. Therefore, substituted cycloalkyl, aryl, heterocyclyl and heteroaryl groups may also be substituted with substituted or unsubstituted alkyl, alkenyl, and alkynyl groups as defined below.

Alkyl groups include straight chain and branched chain alkyl groups having from 1 to 12 carbon atoms, and typically from 1 to 10 carbons or, in some embodiments, from 1 to 8, 1 to 6, or 1 to 4 carbon atoms. Alkyl groups may be substituted or unsubstituted. Examples of straight chain alkyl groups include groups such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above, and include without limitation haloalkyl (e.g., trifluoromethyl), hydroxyalkyl, thioalkyl, aminoalkyl, alkylaminoalkyl, dialkylaminoalkyl, alkoxyalkyl, carboxyalkyl, and the like.

Cycloalkyl groups include mono-, bi- or tricyclic alkyl groups having from 3 to 12 carbon atoms in the ring(s), or, in some embodiments, 3 to 10, 3 to 8, or 3 to 4, 5, or 6 carbon atoms. Cycloalkyl groups may be substituted or unsubstituted. Exemplary monocyclic cycloalkyl groups include, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 3 to 6, or 3 to 7. Bi- and tricyclic ring systems include both bridged cycloalkyl groups and fused rings, such as, but not limited to, bicyclo[2.1.1]hexane, adamantyl, decalinyl, and the like. Substituted cycloalkyl groups may be substituted one or more times with, non-hydrogen and non-carbon groups as defined above. However, substituted cycloalkyl groups also include rings that are substituted with straight or branched chain alkyl groups as defined above. Representative substituted cycloalkyl groups may be mono-substituted or substituted more than once, such as, but not limited to, 2,2-, 2,3-, 2,4- 2,5- or 2,6-disubstituted cyclohexyl groups, which may be substituted with substituents such as those listed above.

Cycloalkylalkyl groups are alkyl groups as defined above in which a hydrogen or carbon bond of an alkyl group is replaced with a bond to a cycloalkyl group as defined above. Cycloalkylalkyl groups may be substituted or unsubstituted. In some embodiments, cycloalkylalkyl groups have from 4 to 16 carbon atoms, 4 to 12 carbon atoms, and typically 4 to 10 carbon atoms. Substituted cycloalkylalkyl groups may be substituted at the alkyl, the cycloalkyl or both the alkyl and cycloalkyl portions of the group. Representative substituted cycloalkylalkyl groups may be mono-substituted or substituted more than once, such as, but not limited to, mono-, di- or tri-substituted with substituents such as those listed above.

Alkenyl groups include straight and branched chain alkyl groups as defined above, except that at least one double bond exists between two carbon atoms. Alkenyl groups may be substituted or unsubstituted. Alkenyl groups have from 2 to 12 carbon atoms, and typically from 2 to 10 carbons or, in some embodiments, from 2 to 8, 2 to 6, or 2 to 4 carbon atoms. In some embodiments, the alkenyl group has one, two, or three carbon-carbon double bonds. Examples include, but are not limited to vinyl, allyl, —CH═CH(CH₃), —CH═C(CH₃)₂, —C(CH₃)═CH₂, —C(CH₃)═CH(CH₃), —C(CH₂CH₃)═CH₂, among others. Representative substituted alkenyl groups may be mono-substituted or substituted more than once, such as, but not limited to, mono-, di- or tri-substituted with substituents such as those listed above.

Cycloalkenyl groups include cycloalkyl groups as defined above, having at least one double bond between two carbon atoms. Cycloalkenyl groups may be substituted or unsubstituted. In some embodiments the cycloalkenyl group may have one, two or three double bonds but does not include aromatic compounds. Cycloalkenyl groups have from 4 to 14 carbon atoms, or, in some embodiments, 5 to 14 carbon atoms, 5 to 10 carbon atoms, or even 5, 6, 7, or 8 carbon atoms. Examples of cycloalkenyl groups include cyclohexenyl, cyclopentenyl, cyclohexadienyl, cyclobutadienyl, and cyclopentadienyl.

Cycloalkenylalkyl groups are alkyl groups as defined above in which a hydrogen or carbon bond of the alkyl group is replaced with a bond to a cycloalkenyl group as defined above. Cycloalkenylalkyl groups may be substituted or unsubstituted. Substituted cycloalkenylalkyl groups may be substituted at the alkyl, the cycloalkenyl or both the alkyl and cycloalkenyl portions of the group. Representative substituted cycloalkenylalkyl groups may be substituted one or more times with substituents such as those listed above.

Alkynyl groups include straight and branched chain alkyl groups as defined above, except that at least one triple bond exists between two carbon atoms. Alkynyl groups may be substituted or unsubstituted. Alkynyl groups have from 2 to 12 carbon atoms, and typically from 2 to 10 carbons or, in some embodiments, from 2 to 8, 2 to 6, or 2 to 4 carbon atoms. In some embodiments, the alkynyl group has one, two, or three carbon-carbon triple bonds. Examples include, but are not limited to —C≡CH, —C≡CCH₃, —CH₂C≡CCH₃, and —C≡CCH₂CH(CH₂CH₃)₂, among others. Representative substituted alkynyl groups may be mono-substituted or substituted more than once, such as, but not limited to, mono-, di- or tri-substituted with substituents such as those listed above.

Aryl groups are cyclic aromatic hydrocarbons that do not contain heteroatoms. Aryl groups herein include monocyclic, bicyclic and tricyclic ring systems. Aryl groups may be substituted or unsubstituted. Thus, aryl groups include, but are not limited to, phenyl, azulenyl, heptalenyl, biphenyl, fluorenyl, phenanthrenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. In some embodiments, the aryl groups are phenyl or naphthyl. The phrase “aryl groups” includes groups containing fused rings, such as fused aromatic-aliphatic ring systems (e.g., indanyl, tetrahydronaphthyl, and the like). Representative substituted aryl groups may be mono-substituted (e.g., tolyl) or substituted more than once. For example, monosubstituted aryl groups include, but are not limited to, 2-, 3-, 4-, 5-, or 6-substituted phenyl or naphthyl groups, which may be substituted with substituents such as those listed above.

Aralkyl groups are alkyl groups as defined above in which a hydrogen or carbon bond of an alkyl group is replaced with a bond to an aryl group as defined above. Aralkyl groups may be substituted or unsubstituted. In some embodiments, aralkyl groups contain 7 to 16 carbon atoms, 7 to 14 carbon atoms, or 7 to 10 carbon atoms. Substituted aralkyl groups may be substituted at the alkyl, the aryl or both the alkyl and aryl portions of the group. Representative aralkyl groups include but are not limited to benzyl and phenethyl groups and fused (cycloalkylaryl)alkyl groups such as 4-indanylethyl. Representative substituted aralkyl groups may be substituted one or more times with substituents such as those listed above.

Heterocyclyl groups include aromatic (also referred to as heteroaryl) and non-aromatic ring compounds containing 3 or more ring members, of which one or more is a heteroatom such as, but not limited to, N, O, and S. Heterocyclyl groups may be substituted or unsubstituted. In some embodiments, the heterocyclyl group contains 1, 2, 3 or 4 heteroatoms. In some embodiments, heterocyclyl groups include mono-, bi- and tricyclic rings having 3 to 16 ring members, whereas other such groups have 3 to 6, 3 to 10, 3 to 12, or 3 to 14 ring members. Heterocyclyl groups encompass aromatic, partially unsaturated and saturated ring systems, such as, for example, imidazolyl, imidazolinyl and imidazolidinyl groups. The phrase “heterocyclyl group” includes fused ring species including those comprising fused aromatic and non-aromatic groups, such as, for example, benzotriazolyl, 2,3-dihydrobenzo[1,4]dioxinyl, and benzo[1,3]dioxolyl. The phrase also includes bridged polycyclic ring systems containing a heteroatom such as, but not limited to, quinuclidyl. The phrase includes heterocyclyl groups that have other groups, such as alkyl, oxo or halo groups, bonded to one of the ring members, referred to as “substituted heterocyclyl groups”. Heterocyclyl groups include, but are not limited to, aziridinyl, azetidinyl, pyrrolidinyl, imidazolidinyl, pyrazolidinyl, thiazolidinyl, tetrahydrothiophenyl, tetrahydrofuranyl, dioxolyl, furanyl, thiophenyl, pyrrolyl, pyrrolinyl, imidazolyl, imidazolinyl, pyrazolyl, pyrazolinyl, triazolyl, tetrazolyl, oxazolyl, isoxazolyl, thiazolyl, thiazolinyl, isothiazolyl, thiadiazolyl, oxadiazolyl, piperidyl, piperazinyl, morpholinyl, thiomorpholinyl, tetrahydropyranyl, tetrahydrothiopyranyl, oxathiane, dioxyl, dithianyl, pyranyl, pyridyl, pyrimidinyl, pyridazinyl, pyrazinyl, triazinyl, dihydropyridyl, dihydrodithiinyl, dihydrodithionyl, homopiperazinyl, quinuclidyl, indolyl, indolinyl, isoindolyl, azaindolyl (pyrrolopyridyl), indazolyl, indolizinyl, benzotriazolyl, benzimidazolyl, benzofuranyl, benzothiophenyl, benzthiazolyl, benzoxadiazolyl, benzoxazinyl, benzodithiinyl, benzoxathiinyl, benzothiazinyl, benzoxazolyl, benzothiazolyl, benzothiadiazolyl, benzo[1,3]dioxolyl, pyrazolopyridyl, imidazopyridyl (azabenzimidazolyl), triazolopyridyl, isoxazolopyridyl, purinyl, xanthinyl, adeninyl, guaninyl, quinolinyl, isoquinolinyl, quinolizinyl, quinoxalinyl, quinazolinyl, cinnolinyl, phthalazinyl, naphthyridinyl, pteridinyl, thianaphthyl, dihydrobenzothiazinyl, dihydrobenzofuranyl, dihydroindolyl, dihydrobenzodioxinyl, tetrahydroindolyl, tetrahydroindazolyl, tetrahydrobenzimidazolyl, tetrahydrobenzotriazolyl, tetrahydropyrrolopyridyl, tetrahydropyrazolopyridyl, tetrahydroimidazopyridyl, tetrahydrotriazolopyridyl, and tetrahydroquinolinyl groups. Representative substituted heterocyclyl groups may be mono-substituted or substituted more than once, such as, but not limited to, pyridyl or morpholinyl groups, which are 2-, 3-, 4-, 5-, or 6-substituted, or disubstituted with various substituents such as those listed above.

Heteroaryl groups are aromatic ring compounds containing 5 or more ring members, of which, one or more is a heteroatom such as, but not limited to, N, O, and S. Heteroaryl groups may be substituted or unsubstituted. Heteroaryl groups include, but are not limited to, groups such as pyrrolyl, pyrazolyl, triazolyl, tetrazolyl, oxazolyl, isoxazolyl, thiazolyl, pyridinyl, pyridazinyl, pyrimidinyl, pyrazinyl, thiophenyl, benzothiophenyl, furanyl, benzofuranyl, indolyl, azaindolyl (pyrrolopyridinyl), indazolyl, benzimidazolyl, imidazopyridinyl (azabenzimidazolyl), pyrazolopyridinyl, triazolopyridinyl, benzotriazolyl, benzoxazolyl, benzothiazolyl, benzothiadiazolyl, imidazopyridinyl, isoxazolopyridinyl, thianaphthyl, purinyl, xanthinyl, adeninyl, guaninyl, quinolinyl, isoquinolinyl, tetrahydroquinolinyl, quinoxalinyl, and quinazolinyl groups. Heteroaryl groups include fused ring compounds in which all rings are aromatic such as indolyl groups and include fused ring compounds in which only one of the rings is aromatic, such as 2,3-dihydro indolyl groups. Representative substituted heteroaryl groups may be substituted one or more times with various substituents such as those listed above.

Heterocyclylalkyl groups are alkyl groups as defined above in which a hydrogen or carbon bond of an alkyl group is replaced with a bond to a heterocyclyl group as defined above. Heterocyclylalkyl groups may be substituted or unsubstituted. Substituted heterocyclylalkyl groups may be substituted at the alkyl, the heterocyclyl or both the alkyl and heterocyclyl portions of the group. Representative heterocyclyl alkyl groups include, but are not limited to, morpholin-4-yl-ethyl, furan-2-yl-methyl, imidazol-4-yl-methyl, pyridin-3-yl-methyl, tetrahydrofuran-2-yl-ethyl, and indol-2-yl-propyl. Representative substituted heterocyclylalkyl groups may be substituted one or more times with substituents such as those listed above.

Heteroaralkyl groups are alkyl groups as defined above in which a hydrogen or carbon bond of an alkyl group is replaced with a bond to a heteroaryl group as defined above. Heteroaralkyl groups may be substituted or unsubstituted. Substituted heteroaralkyl groups may be substituted at the alkyl, the heteroaryl or both the alkyl and heteroaryl portions of the group. Representative substituted heteroaralkyl groups may be substituted one or more times with substituents such as those listed above.

Groups described herein having two or more points of attachment (i.e., divalent, trivalent, or polyvalent) within the compound of the present technology are designated by use of the suffix, “ene.” For example, divalent alkyl groups are alkylene groups, divalent aryl groups are arylene groups, divalent heteroaryl groups are divalent heteroarylene groups, and so forth. Substituted groups having a single point of attachment to the compound of the present technology are not referred to using the “ene” designation. Thus, e.g., chloroethyl is not referred to herein as chloroethylene.

Alkoxy groups are hydroxyl groups (—OH) in which the bond to the hydrogen atom is replaced by a bond to a carbon atom of a substituted or unsubstituted alkyl group as defined above. Alkoxy groups may be substituted or unsubstituted. Examples of linear alkoxy groups include but are not limited to methoxy, ethoxy, propoxy, butoxy, pentoxy, hexoxy, and the like. Examples of branched alkoxy groups include but are not limited to isopropoxy, sec-butoxy, tert-butoxy, isopentoxy, isohexoxy, and the like. Examples of cycloalkoxy groups include but are not limited to cyclopropyloxy, cyclobutyloxy, cyclopentyloxy, cyclohexyloxy, and the like. Representative substituted alkoxy groups may be substituted one or more times with substituents such as those listed above.

The terms “alkanoyl” and “alkanoyloxy” as used herein can refer, respectively, to —C(O)-alkyl groups and —O—C(O)-alkyl groups, each containing 2-5 carbon atoms. Similarly, “aryloyl” and “aryloyloxy” refer to —C(O)-aryl groups and —O—C(O)-aryl groups.

The terms “aryloxy” and “arylalkoxy” refer to, respectively, a substituted or unsubstituted aryl group bonded to an oxygen atom and a substituted or unsubstituted aralkyl group bonded to the oxygen atom at the alkyl. Examples include but are not limited to phenoxy, naphthyloxy, and benzyloxy. Representative substituted aryloxy and arylalkoxy groups may be substituted one or more times with substituents such as those listed above.

The term “carboxylate” as used herein refers to a —COOH group.

The term “ester” as used herein refers to —COOR⁷⁰ and —C(O)O-G groups. R⁷⁰ is a substituted or unsubstituted alkyl, cycloalkyl, alkenyl, alkynyl, aryl, aralkyl, heterocyclylalkyl or heterocyclyl group as defined herein. G is a carboxylate protecting group. Carboxylate protecting groups are well known to one of ordinary skill in the art. An extensive list of protecting groups for the carboxylate group functionality may be found in Protective Groups in Organic Synthesis, Greene, T. W.; Wuts, P. G. M., John Wiley & Sons, New York, NY, (3rd Edition, 1999) which can be added or removed using the procedures set forth therein and which is hereby incorporated by reference in its entirety and for any and all purposes as if fully set forth herein.

The term “amide” (or “amido”) includes C- and N-amide groups, i.e., —C(O)NR⁷¹R⁷², and —NR⁷¹C(O)R⁷² groups, respectively. R⁷¹ and R⁷² are independently hydrogen, or a substituted or unsubstituted alkyl, alkenyl, alkynyl, cycloalkyl, aryl, aralkyl, heterocyclylalkyl or heterocyclyl group as defined herein. Amido groups therefore include but are not limited to carbamoyl groups (—C(O)NH₂) and formamide groups (—NHC(O)H). In some embodiments, the amide is —NR⁷¹C(O)—(C₁-5 alkyl) and the group is termed “carbonylamino,” and in others the amide is —NHC(O)-alkyl and the group is termed “alkanoylamino.”

The term “nitrile” or “cyano” as used herein refers to the —CN group.

Urethane groups include N- and O-urethane groups, i.e., —NR⁷³C(O)OR⁷⁴ and —OC(O)NR⁷³R⁷⁴ groups, respectively. R⁷³ and R⁷⁴ are independently a substituted or unsubstituted alkyl, alkenyl, alkynyl, cycloalkyl, aryl, aralkyl, heterocyclylalkyl, or heterocyclyl group as defined herein. R⁷³ may also be H.

The term “amine” (or “amino”) as used herein refers to —NR⁷⁵R⁷⁶ groups, wherein R⁷⁵ and R⁷⁶ are independently hydrogen, or a substituted or unsubstituted alkyl, alkenyl, alkynyl, cycloalkyl, aryl, aralkyl, heterocyclylalkyl or heterocyclyl group as defined herein. In some embodiments, the amine is alkylamino, dialkylamino, arylamino, or alkylarylamino. In other embodiments, the amine is NH₂, methylamino, dimethylamino, ethylamino, diethylamino, propylamino, isopropylamino, phenylamino, or benzylamino.

The term “sulfonamido” includes S- and N-sulfonamide groups, i.e., —SO₂NR⁷⁸R⁷⁹ and —NR⁷⁸SO₂R⁷⁹ groups, respectively. R⁷⁸ and R⁷⁹ are independently hydrogen, or a substituted or unsubstituted alkyl, alkenyl, alkynyl, cycloalkyl, aryl, aralkyl, heterocyclylalkyl, or heterocyclyl group as defined herein. Sulfonamido groups therefore include but are not limited to sulfamoyl groups (—SO₂NH₂). In some embodiments herein, the sulfonamido is —NHSO₂-alkyl and is referred to as the “alkylsulfonylamino” group.

The term “thiol” refers to —SH groups, while “sulfides” include —SR⁸⁰ groups, “sulfoxides” include —S(O)R⁸¹ groups, “sulfones” include —SO₂R⁸² groups, and “sulfonyls” include —SO₂OR⁸³. R⁸⁰, R⁸¹, R⁸², and R⁸³ are each independently a substituted or unsubstituted alkyl, cycloalkyl, alkenyl, alkynyl, aryl aralkyl, heterocyclyl or heterocyclylalkyl group as defined herein. In some embodiments the sulfide is an alkylthio group, —S-alkyl.

The term “urea” refers to —NR⁸⁴—C(O)—NR⁸⁵R⁸⁶ groups. R⁸⁴, R⁸⁵, and R⁸⁶ groups are independently hydrogen, or a substituted or unsubstituted alkyl, alkenyl, alkynyl, cycloalkyl, aryl, aralkyl, heterocyclyl, or heterocyclylalkyl group as defined herein.

The term “amidine” refers to —C(NR⁸⁷)NR⁸⁸R⁸⁹ and —NR⁸⁷C(NR⁸⁸)R⁸⁹, wherein R⁸⁷, R⁸⁸, and R⁸⁹ are each independently hydrogen, or a substituted or unsubstituted alkyl, cycloalkyl, alkenyl, alkynyl, aryl aralkyl, heterocyclyl or heterocyclylalkyl group as defined herein.

The term “guanidine” refers to —NR⁹⁰C(NR⁹¹)NR⁹²R⁹³, wherein R⁹⁰, R⁹¹, R⁹² and R⁹³ are each independently hydrogen, or a substituted or unsubstituted alkyl, cycloalkyl, alkenyl, alkynyl, aryl aralkyl, heterocyclyl or heterocyclylalkyl group as defined herein.

The term “enamine” refers to —C(R⁹⁴)═C(R⁹⁵)NR⁹⁶R⁹⁷ and —NR⁹⁴C(R⁹⁵)═C(R⁹⁶) R⁹⁷, wherein R⁹⁴, R⁹⁵, R⁹⁶ and R⁹⁷ are each independently hydrogen, a substituted or unsubstituted alkyl, cycloalkyl, alkenyl, alkynyl, aryl aralkyl, heterocyclyl or heterocyclylalkyl group as defined herein.

The term “halogen” or “halo” as used herein refers to bromine, chlorine, fluorine, or iodine. In some embodiments, the halogen is fluorine. In other embodiments, the halogen is chlorine or bromine.

The term “hydroxyl” as used herein can refer to —OH or its ionized form, —O⁻. A “hydroxyalkyl” group is a hydroxyl-substituted alkyl group, such as HO—CH₂—.

The term “imide” refers to —C(O)NR⁹⁸C(O)R⁹⁹, wherein R⁹⁸ and R⁹⁹ are each independently hydrogen, or a substituted or unsubstituted alkyl, cycloalkyl, alkenyl, alkynyl, aryl aralkyl, heterocyclyl or heterocyclylalkyl group as defined herein.

The term “imine” refers to —CR¹⁰⁰(NR¹⁰¹) and —N(CR¹⁰⁰R¹⁰¹) groups, wherein R¹⁰⁰ and R¹⁰¹ are each independently hydrogen or a substituted or unsubstituted alkyl, cycloalkyl, alkenyl, alkynyl, aryl aralkyl, heterocyclyl or heterocyclylalkyl group as defined herein, with the proviso that R¹⁰⁰ and R¹⁰¹ are not both simultaneously hydrogen.

The term “nitro” as used herein refers to an —NO₂ group.

The term “trifluoromethyl” as used herein refers to —CF₃.

The term “trifluoromethoxy” as used herein refers to —OCF₃.

The term “azido” refers to —N₃.

The term “trialkyl ammonium” refers to a —N(alkyl)₃ group. A trialkylammonium group is positively charged and thus typically has an associated anion, such as halogen anion.

The term “isocyano” refers to —NC.

The term “isothiocyano” refers to —NCS.

The term “pentafluorosulfanyl” refers to —SF₅.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 atoms refers to groups having 1, 2, or 3 atoms. Similarly, a group having 1-5 atoms refers to groups having 1, 2, 3, 4, or 5 atoms, and so forth.

As understood by one of ordinary skill in the art, “molecular weight” (also known as “relative molar mass”) is a dimensionless quantity but is converted to molar mass by multiplying by 1 gram/mole or by multiplying by 1 Da—for example, a compound with a weight-average molecular weight of 5,000 has a weight-average molar mass of 5,000 g/mol and a weight-average molar mass of 5,000 Da.

Those of skill in the art will appreciate that compounds of the present technology may exhibit the phenomena of tautomerism, conformational isomerism, geometric isomerism, and/or stereoisomerism. As the formula drawings within the specification and claims can represent only one of the possible tautomeric, conformational isomeric, stereochemical or geometric isomeric forms, it should be understood that the present technology encompasses any tautomeric, conformational isomeric, stereochemical and/or geometric isomeric forms of the compounds having one or more of the utilities described herein, as well as mixtures of these various different forms.

“Tautomers” refers to isomeric forms of a compound that are in equilibrium with each other. The presence and concentrations of the isomeric forms will depend on the environment the compound is found in and may be different depending upon, for example, whether the compound is a solid or is in an organic or aqueous solution. For example, in aqueous solution, quinazolinones may exhibit the following isomeric forms, which are referred to as tautomers of each other:

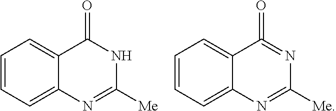

As another example, guanidines may exhibit the following isomeric forms in protic organic solution, also referred to as tautomers of each other:

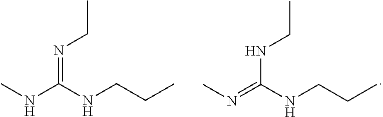

Because of the limits of representing compounds by structural formulas, it is to be understood that all chemical formulas of the compounds described herein represent all tautomeric forms of compounds and are within the scope of the present technology.

Stereoisomers of compounds (also known as optical isomers) include all chiral, diastereomeric, and racemic forms of a structure, unless the specific stereochemistry is expressly indicated. Thus, compounds used in the present technology include enriched or resolved optical isomers at any or all asymmetric atoms as are apparent from the depictions. Both racemic and diastereomeric mixtures, as well as the individual optical isomers can be isolated or synthesized so as to be substantially free of their enantiomeric or diastereomeric partners, and these stereoisomers are all within the scope of the present technology.

The compounds of the present technology may exist as solvates, especially hydrates. Hydrates may form during manufacture of the compounds or compositions comprising the compounds, or hydrates may form over time due to the hygroscopic nature of the compounds. Compounds of the present technology may exist as organic solvates as well, including DMF, ether, and alcohol solvates among others. The identification and preparation of any particular solvate is within the skill of the ordinary artisan of synthetic organic chemistry.

### The Present Technology

For colloidal silica to be used under extreme conditions (e.g., high divalent metal salt solutions, high trivalent metal salt solutions, low pH, and/or high temperatures) with applications such as enhanced oil recovery, metal surface treatments, and electroplating formulations, colloidal stability is a more stringent requirement. Indeed, as shown by the Comparative Examples disclosed herein, functionalized colloidal silica available prior to the present disclosure suffers stability issues in such extreme conditions.

The present technology addresses the above-discussed deficiencies—including in relation to metal surface treatments and electroplating formulations—as well as provides additional advantages. Thus, in an aspect, the present technology provides a composition that includes water and a functionalized colloidal silica. The functionalized colloidal silica includes silica particles (where each silica particle includes a surface) and a structural unit according to Formula I and/or a structural unit according to Formula II

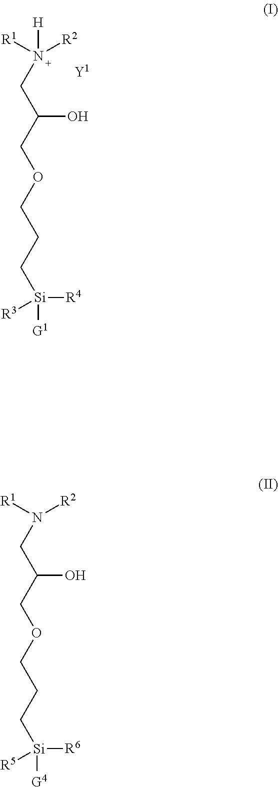

where
R¹ is H, unsubstituted alkyl, a hydroxyl-substituted alkyl, an alkoxy-substituted alkyl, a hydroxyl-substituted cycloalkyl, aryl, or heteroaryl;
R² is a hydroxyl-substituted alkyl, an alkoxy-substituted alkyl, or a hydroxyl-substituted cycloalkyl;
or R¹ and R² taken together are a hydroxyl-substituted C₄-C₆ alkylene group;
R³ is hydroxyl, alkoxy, aryloxy, or G²;
R⁴ is hydroxyl, alkoxy, aryloxy, or G³;
R⁵ is hydroxyl, alkoxy, aryloxy, or G⁵;
R⁶ is hydroxyl, alkoxy, aryloxy, or G⁶;
G¹, G², G³, G⁴, G⁵, and G⁶ are each independently an oxygen atom of the surface of the silica particle, where G¹, G², G³, G⁴, G⁵, and G⁶ are not the same oxygen atom; and
Y¹ is an anion.

The composition may, in any embodiment herein, include a pH of about 8.5 or lower; thus, the composition of any embodiment herein may include a pH of about 8.5, about 8.0, about 7.5, about 7.0, about 6.5, about 6.0, about 5.5, about 5.0, about 4.5, about 4.0, about 3.5, about 3.0, about 2.5, about 2.0, about 1.5, about 1.0, a range less than any one of these values, or any range including and/or in-between any two of these values. In any embodiment where the composition includes a pH of about 8.5 or lower, the functionalized colloidal silica may include a positive zeta potential. The positive zeta potential of any such embodiment herein may be about +1 millivolt (“mV”), about +2 mV, about +3 mV, about +4 mV, about +5 mV, about +6 mV, about +7 mV, about +8 mV, about +9 mV, about +10 mV, about +15 mV, about +20 mV, about +25 mV, about +30 mV, about +35 mV, about +40 mV, about +45 mV, about +50 mV, about +55 mV, about +60 mV, about +65 mV, about +70 mV, a range greater than any one of these values, or any range including and/or in-between any two of these values. In any embodiment where the composition includes a pH of about 8.5 or lower, the composition may include a molar ratio of structural units according to Formula I to structural units according to Formula II (i.e., [moles of structural units according to Formula I]/[moles of structural units according to Formula II]) of about 1:1 or greater. Thus, in any embodiment where the composition includes a pH of about 8.5 or lower, the composition may include a molar ratio of structural units according to Formula I to structural units according to Formula II about 1:1, about 2:1, about 3:1, about 4:1, about 5:1, about 6:1, about 7:1, about 8:1, about 9:1, about 10:1, about 20:1, about 30:1, about 40:1, about 50:1, about 100:1, about 1,000:1, a range greater than any one of these value, or any range including and/or in-between any two of these values. In any embodiment herein, the silica particles may have a median diameter as determined by dynamic light scattering of about 1 nm to about 100 nm (D50 on a volume basis). Thus, the median diameter of the silica particles as determined by dynamic light scattering may be about 1 nm, about 5 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, or any range including and/or in-between any two of these values.

In any embodiment herein, the silica particles may have a Sears surface area of about 25 m²/g to about 1,200 m²/g. See Sears, “Determination of Specific Area of Colloidal Silica by Titration with Sodium Hydroxide” Analytical Chemistry 1956, 28 (12), 1981-1983 https://doi.org/10.1021/ac60120a048. Thus, the silica particles of any embodiment herein may have a Sears surface area of about 25 m²/g, 26 m²/g, 27 m²/g, 28 m²/g, 29 m²/g, 30 m²/g, 35 m²/g, 40 m²/g, 45 m²/g, 50 m²/g, 55 m²/g, 60 m²/g, 70 m²/g, 80 m²/g, 90 m²/g, 100 m²/g, 150 m²/g, 200 m²/g, 250 m²/g, 300 m²/g, 350 m²/g, 400 m²/g, 450 m²/g, 500 m²/g, 550 m²/g, 600 m²/g, 650 m²/g, 700 m²/g, 750 m²/g, 800 m²/g, 850 m²/g, 900 m²/g, 950 m²/g, 1,000 m²/g, 1,100 m²/g, 1,200 m²/g, or any range including and/or in-between any two of these values.

The composition of any embodiment herein may include a number of structural units according to Formula I and/or Formula II per nm² surface area of about 0.8 to about 3.5. Accordingly, the composition of any embodiment herein may include a number of structural units according to Formula I and/or Formula II per nm² surface area of about 0.8, about 0.9, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, or any range including and/or in-between any two of these values.

In any embodiment herein, it may be that R¹ is H, unsubstituted alkyl, a hydroxyl-substituted alkyl, an alkoxy-substituted alkyl, a hydroxyl-substituted cycloalkyl, an amine-substituted aryl, a hydroxyl-substituted aryl, or heteroaryl. In any embodiment herein, it may be that R³ is hydroxyl, methoxy, ethoxy, propoxy, phenoxy, or G². In any embodiment herein, it may be that it may be that R⁴ is hydroxyl, methoxy, ethoxy, propoxy, phenoxy, or G³. In any embodiment herein, it may be that it may be that R⁵ is hydroxyl, methoxy, ethoxy, propoxy, phenoxy, or G⁵. In any embodiment herein, it may be that it may be that R⁶ is hydroxyl, methoxy, ethoxy, propoxy, phenoxy, or G⁶. In any embodiment herein, it may be that R¹ is H, methyl, ethyl, a hydroxyl-substituted C₂-C₆ alkyl, or an alkoxy-substituted C₂-C₆ alkyl; R² is a hydroxyl-substituted C₂-C₆ alkyl or an alkoxy-substituted C₂-C₆ alkyl; or R¹ and R² taken together are a hydroxyl-substituted C₄-C₆ alkylene group. In any embodiment herein, it may be that R³ is G². In any embodiment herein, it may be that R⁴ is hydroxyl. In any embodiment herein, the silica particles may include at least one structural unit according to Formula Ia, Ib, Ic, Id, Ie, If, or Ig

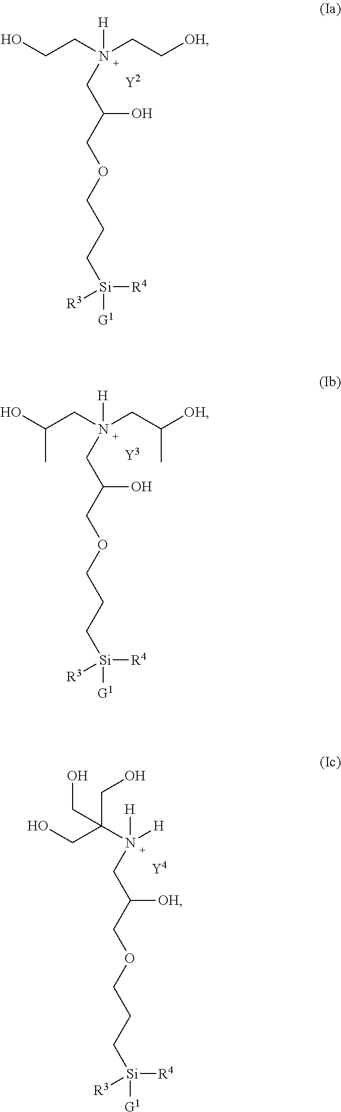

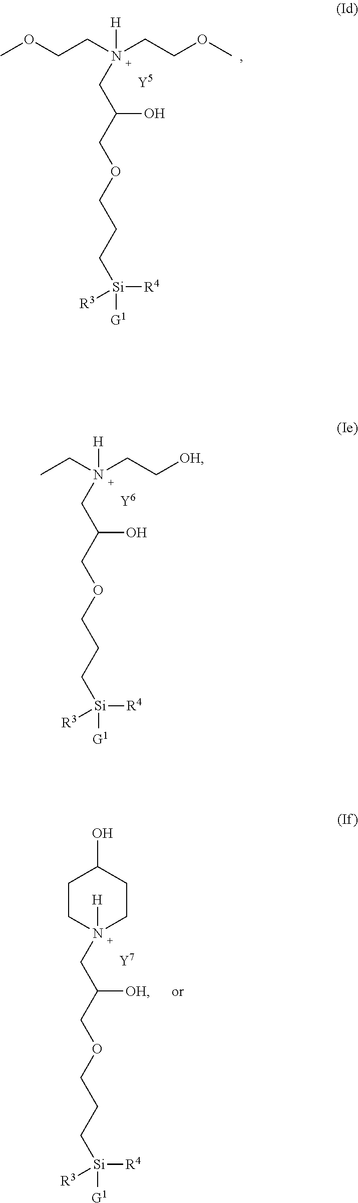

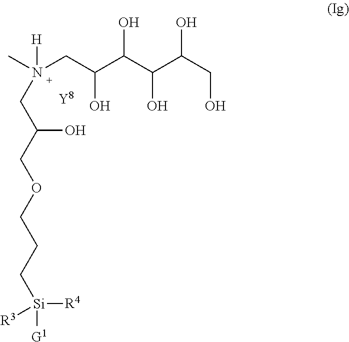

where Y², Y³, Y⁴, Y⁵, Y⁶, Y⁷, and Y⁸ are independently at each occurrence an anion.

In any embodiment herein, Y¹, Y², Y³, Y⁴, Y⁵, Y⁶, Y⁷, and Y⁸ may independently at each occurrence be Cl⁻, NO₃⁻, or SO₄⁻². In any embodiment herein, it may be that the silica particles further include at least one structural unit according to Formula III

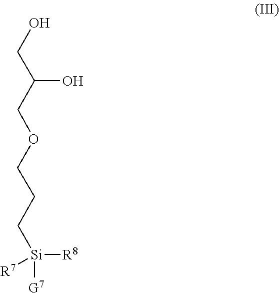

wherein
   R⁷ is hydroxyl, alkoxy, aryloxy, or G⁸;
   R⁸ is hydroxyl, alkoxy, aryloxy, or G⁹;
   G⁷, G⁸, and Go are each independently an oxygen atom of the surface of the silica particle, where G⁷, G⁸, and Go are not the same oxygen atom.
      In any embodiment herein, it may be that R⁷ is hydroxyl, methoxy, ethoxy, propoxy, phenoxy, or G⁸. In any embodiment herein, it may be that it may be that R⁸ is hydroxyl, methoxy, ethoxy, propoxy, phenoxy, or G⁹.

The composition of any embodiment herein may include about 0.1 wt % to about 50 wt % of the functionalized colloidal silica. Thus, in any embodiment herein the composition may include the functionalized colloidal silica in an amount of about 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 15 wt %, 20 wt %, 25 wt %, 30 wt %, 35 wt %, 40 wt %, 45 wt %, 50 wt %, or any range including and/or in-between any two of these values. For example, in any embodiment herein the composition may include the functionalized colloidal silica in an amount of about 0.1 wt % to about 30 wt %, about 5 wt % to about 30 wt %, about 10 wt % to about 30 wt %, or about 0.1 wt % to about 5 wt %.

The composition of any embodiment herein may be stable to aging for 24 hours or longer at temperature of 80° C. when the composition comprises a salt solution at an ionic strength of 0.5 to 3.0. The salt solution of any embodiment herein may include NaCl, CaCl₂, MgSO₄, or a combination of any two or more thereof. In any embodiment herein, the ionic strength may be 0.5, 1.0, 2.0, 3.0, or any range including and/or in-between any two of these values. When the composition comprises a salt solution at an ionic strength of 0.5 to 3.0, in any such embodiment the composition may be at a pH of about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, or any range including and/or in-between any two of these values.

In another aspect, the present technology provides a method of making a functionalized colloidal silica (for example, a method of making a composition of any embodiment herein). The method includes contacting a colloidal silica with a silane according to Formula IV to yield the functionalized colloidal silica

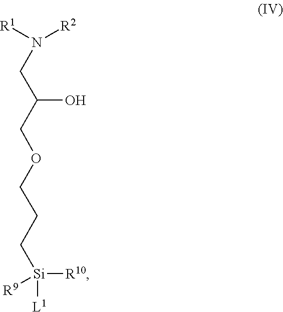

wherein
R¹ is H, unsubstituted alkyl, a hydroxyl-substituted alkyl, an alkoxy-substituted alkyl, a hydroxyl-substituted cycloalkyl, aryl, or heteroaryl;
R² is a hydroxyl-substituted alkyl, an alkoxy-substituted alkyl, or a hydroxyl-substituted cycoalkyl;
or R¹ and R² taken together are a hydroxyl-substituted C₄-C₆ alkylene group;
R⁹ is hydroxyl, alkoxy, or aryloxy;
R¹⁰ is hydroxyl, alkoxy, or aryloxy; and
L¹ is alkoxy or aryloxy.

The colloidal silica may be an aqueous colloidal silica. In any embodiment herein, it may be that R⁷, R⁸, and L¹ are each independently alkoxy or aryloxy. In any embodiment herein, it may be that R⁷, R⁸, and L¹ are each independently alkoxy or aryloxy. In any embodiment herein, it may be that R¹ is H, unsubstituted alkyl, a hydroxyl-substituted alkyl, an alkoxy-substituted alkyl, a hydroxyl-substituted cycloalkyl, an amine-substituted aryl, a hydroxyl-substituted aryl, or heteroaryl. In any embodiment herein, it may be that R⁹ is hydroxyl, methoxy, ethoxy, propoxy, or phenoxy. In any embodiment herein, it may be that it may be that R¹⁰ is hydroxyl, methoxy, ethoxy, propoxy, or phenoxy. In any embodiment herein, it may be that it may be that L¹ is methoxy, ethoxy, propoxy, or phenoxy. In any embodiment herein, it may be that R¹ is H, methyl, ethyl, a hydroxyl-substituted C₂-C₆ alkyl, or an alkoxy-substituted C₂-C₆ alkyl; R² is a hydroxyl-substituted C₂-C₆ alkyl or an alkoxy-substituted C₂-C₆ alkyl; or R¹ and R² taken together are a hydroxyl-substituted C₄-C₆ alkylene group.

In any embodiment herein of the method, the functionalized colloidal silica may include a surface as well as a structural unit according to Formula I and/or a structural unit according to Formula II

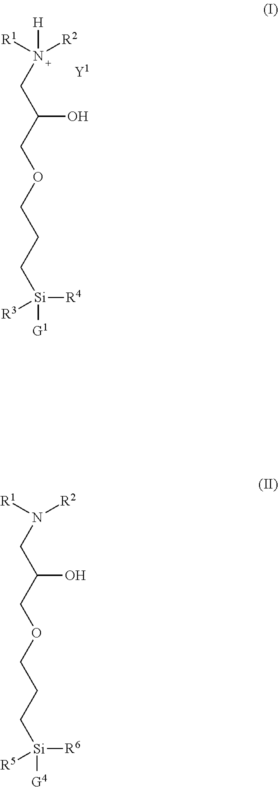

wherein
   R³ is hydroxyl, alkoxy, aryloxy, or G²;
   R⁴ is hydroxyl, alkoxy, aryloxy, or G³;
   R⁵ is hydroxyl, alkoxy, aryloxy, or G⁵;
   R⁶ is hydroxyl, alkoxy, aryloxy, or G⁶;
   G¹, G², G³, G⁴, G⁵, and G⁶ are each independently an oxygen atom of the surface of the silica particle, where G¹, G², G³, G⁴, G⁵, and G⁶ are not the same oxygen atom; and
   Y¹ is an anion.
      In any embodiment herein, it may be that R³ is hydroxyl, methoxy, ethoxy, propoxy, phenoxy, or G². In any embodiment herein, it may be that it may be that R⁴ is hydroxyl, methoxy, ethoxy, propoxy, phenoxy, or G³. In any embodiment herein, it may be that it may be that R⁵ is hydroxyl, methoxy, ethoxy, propoxy, phenoxy, or G⁵. In any embodiment herein, it may be that it may be that R⁶ is hydroxyl, methoxy, ethoxy, propoxy, phenoxy, or G⁶.

In any embodiment herein of the method, the functionalized colloidal silica may include a surface as well as at least one structural unit according to Formula Ia, Ib, Ic, Id, Ie, If, or Ig

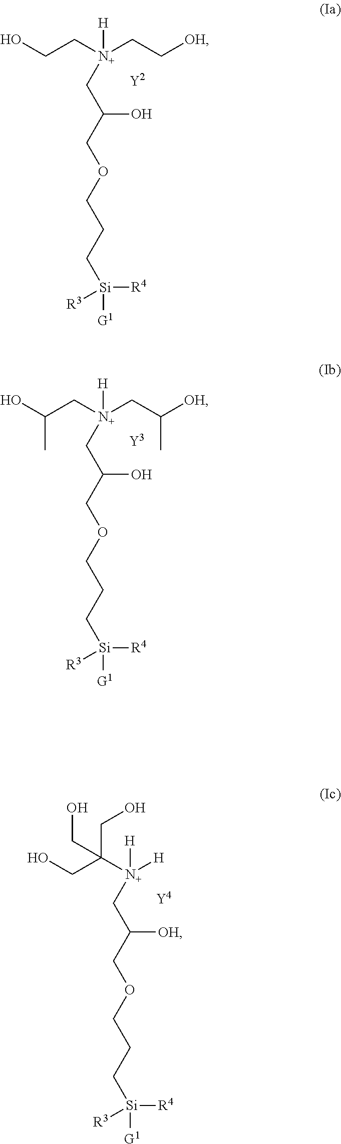

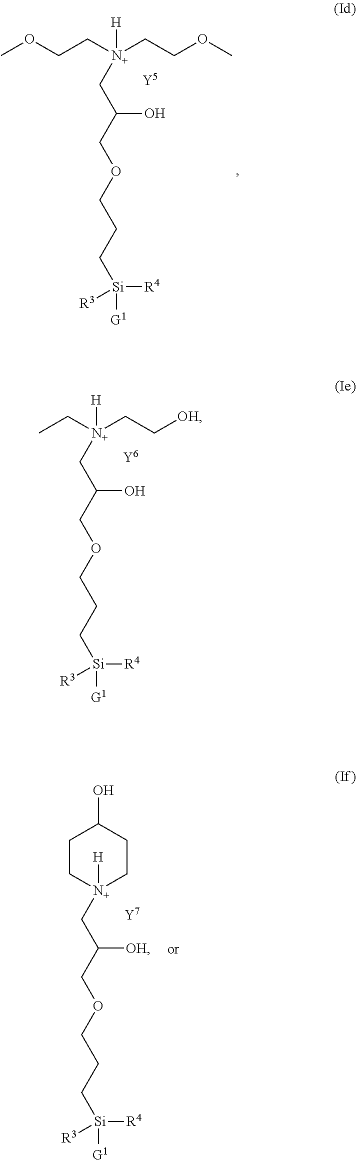

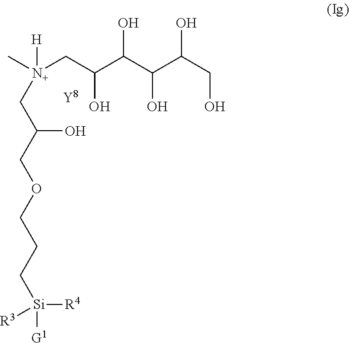

where Y², Y³, Y⁴, Y⁵, Y⁶, Y⁷, and Y⁸ are independently at each occurrence an anion.

In any embodiment herein of the method, Y¹, Y², Y³, Y⁴, Y⁵, Y⁶, Y⁷, and Y⁸ may independently at each occurrence be Cl⁻, NO₃⁻, or SO₄⁻². In any embodiment herein of the method, it may be that the functionalized colloidal silica further includes at least one structural unit according to Formula III

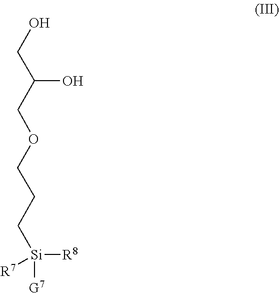

wherein
   R⁷ is hydroxyl, alkoxy, aryloxy, or G⁸;
   R⁸ is hydroxyl, alkoxy, aryloxy, or G⁹;
   G⁷, G⁸, and Go are each independently an oxygen atom of the surface of the silica particle, where G⁷, G⁸, and G⁹ are not the same oxygen atom.
      In any embodiment herein of the method, it may be that R⁷ is hydroxyl, methoxy, ethoxy, propoxy, phenoxy, or G⁸. In any embodiment herein of the method, it may be that it may be that R⁸ is hydroxyl, methoxy, ethoxy, propoxy, phenoxy, or G⁹.

The method of any embodiment herein may include contacting the colloidal silica with the silane in a medium, where the medium includes water and/or a polar organic solvent (e.g., a polar organic solvent miscible with water). In any embodiment where the medium includes a polar organic solvent, the polar organic solvent may include methanol, ethanol, propanol, ethylene glycol, acetone, dimethylformamide, N-methylpyrrolidone, or a combination of any two or more thereof.

The method of any embodiment herein may include contacting about 1.5 to about 3.0 molecules silane per 1 nm² colloidal silica surface area. Thus, in any embodiment herein the method may include contacting an amount of molecules silane per 1 nm² colloidal silica surface area of about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, or any range including and/or in-between any two of these values.

The method of any embodiment herein may provide a composition comprising water and the functionalized colloidal silica (e.g., of any embodiment of the composition aspect of the present technology). In such embodiments, the composition may be stable to aging for 24 hours or longer at temperature of 80° C. when the composition comprises a salt solution at an ionic strength of 0.5 to 3.0. The salt solution of any embodiment herein may include NaCl, CaCl₂, MgSO₄, or a combination of any two or more thereof. In any embodiment herein, the ionic strength may be 0.5, 1.0, 2.0, 3.0, or any range including and/or in-between any two of these values. When the composition comprises a salt solution at an ionic strength of 0.5 to 3.0, in any such embodiment the composition may be at a pH of about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, or any range including and/or in-between any two of these values.

The method of any embodiment herein may include contacting a colloidal silica with a silane according to Formula IV to yield an initial mixture, the initial mixture including the functionalized colloidal silica as well as unreacted silane, a silane not bonded to the colloidal silica, an impurity, or a combination of any two or more thereof; and purifying the functionalized colloidal silica by ultrafiltration of the initial mixture to separate the functionalized colloidal silica from the unreacted silane, the silane not bonded to the colloidal silica, impurity, or a combination of any two or more thereof.

In a further aspect, the present technology provides a functionalized silica prepared according to a method of any embodiment described herein.

The present technology, thus generally described, will be understood more readily by reference to the following examples, which are provided by way of illustration and are not intended to be limiting of the present technology.

### EXAMPLES

Commercially available LUDOX colloidal silica grades were used in these examples. These products were supplied by W. R. Grace &Co. Similar products, such as LEVASIL (available from Nouryon), AMSOL (available from Applied Material Solutions (, KOSTROSOL 1540 (from CWK Chemiewerk Bad Köstritz GmbH), NALCO 1140 (from Nalco Water), SNOWTEX (from Nissan Chemical), etc. may also be used.

All the chemicals used in these examples came from common suppliers such as SigmaAldrich, Fisher Scientific, TCI America and Gelest, Inc. These chemicals were purchased and used without further purifications.

To calculate the silane treatment levels for colloidal silica particles, as shown in Table 1 below, we used 345 m²/g surface area for 7 nm grade of colloidal silica (e.g. LUDOX SM), 220 m²/g surface area for 12 nm grade of colloidal silica (e.g. LUDOX HS-40 or LUDOX AM or LUDOX CL), 140 m²/g surface area for 22 nm grade of colloidal silica (e.g. LUDOX TM-40), and 75 m²/g surface area for 40 nm grade (e.g. LUDOX PW-50 (X), a colloidal silica grade with polydispersed, different sized silica particles). The treatment level (TL) is defined as Number of Molecules per square nanometer of solid particle surface area, or NM/nm².

TABLE 1

| | Median Particle | Sears Surface |
|---|---|---|
| LUDOX Grade | Size (nm) | Area (m²/g) |
| SM | 7 | 345 |
| HS-40/CL | 12 | 220 |
| TM-40 | 22 | 140 |
| PW-50(X) | 40 (multi-modal) | 75 |

In typical procedures of purifying functionalized colloidal silica, SPECTRUM MIDIKROS hollow fiber membranes (e.g. D02-E050-10-S mPES/50 kD MWCO with surface area of 75 cm²) were used (other types of membranes with suitable molecular weight cutoff can also used). The colloidal silica samples were passing through the membranes though TYGON tubing with a peristaltic pump under a pressure of less than 25 psi. The permeates were collected and the total volume was measured. The typical solids for the colloidal silica were between 5-25%, and fresh deionized water was added to make up the volume loss in the permeates. Typically, 5-10 volumes of permeates were accumulated against the initial total volume of the colloidal samples before the completion of the ultrafiltration process.

The general method for elemental analysis of functionalized particles for carbon (C %), Hydrogen (H %) Nitrogen (N %): small amounts of the purified colloidal samples were placed in a glass vials, and the vials were dried in an oven at 90° C. overnight. The dried solids were collected and they were subjected to elemental analysis with LECO G4 ICARUS Series 2 analyzer or PerkinElmer 2400 series.

Titration method: For zeta titrations, a Colloid Dynamics AcoustoSizer IIX coupled to an auto-titrator unit was used to measure zeta potentials as functions of pH by an electroacoustic method. For typical runs, sols were prepared at 5% colloidal solids by dilution of the original sample with deionized water. Potentiometric titrations were performed starting at the sol nascent pH and run either up to pH 9 (for sols with nascent pH on the acid side) or down to pH 3 (for sols with nascent pH on the alkaline side) and then back to either pH 9 or 3, respectively. The pre-loaded instrument parameters for SiO2 (silica, amorphous-typical) and water were used by the software. Titrations were done with 0.1 N HCl and 0.1 N NaOH.

For dynamic light scattering (DLS) particle size measurement, a Malvern Zetasizer Nano-S90 model number ZEN1690 was utilized. Solutions of 2% wt colloidal solids were prepared by dilution of the original sols with deionized water. Once diluted, the sols were filtered with 0.45-micron syringe filter into the measurement cuvette. Measurements were accumulated for 60 seconds. Values reported are D50 on a volume basis.

The method for charactering surface groups of functionalized colloidal particles: the functionalized colloidal silica at approximately 20% solids, after ultrafiltration purification to remove unreacted species, were subjected to NMR analysis. The samples were diluted to around 10% with D20 and they were analyzed on a Bruker Avance III 400 MHz Nuclear Magnetic Resonance (NMR) instrument.

### Example 1 (DEA at 1.7 NM/nm² TL)

In a 20 ml vial, 2.95 g (12.5 mmol) of 3-glycidoxypropyltrimethoxysilane (glycidylsilane) and 1.31 g (12.5 mmol) of diethanolamine (DEA) were mixed with a stir bar. In the beginning, the two liquid compounds were not miscible to each other, and they were in two phases. After about 1 hour of reaction, a single phase was formed, and a new silane was formed with the structure as follows:

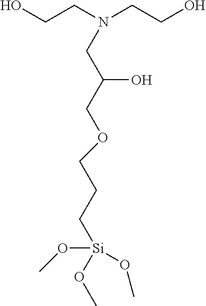 [SMILES: CO[Si](CCCOCC(O)CN(CCO)CCO)(OC)OC]

In a 250 ml beaker, 50 g of LUDOX HS-40 (40% solids, 20 g net SiO₂ solids) were diluted to 30% with an addition of 16.6 g of deionized water. To the stirred colloidal silica was added the new silane dropwise, over 10 minutes. After the addition, the mixture was stirred at room temperature for 1 hour, and then heated to 70° C. for another hour. Then, the mixture was allowed to cool down to room temperature. The resulting mixture was purified by ultrafiltration with 5 volumes of DI water as mentioned above.

A small sample was taken from the purified sample and dried in 90° C. oven overnight. Elemental analysis was carried out for the dried sample.

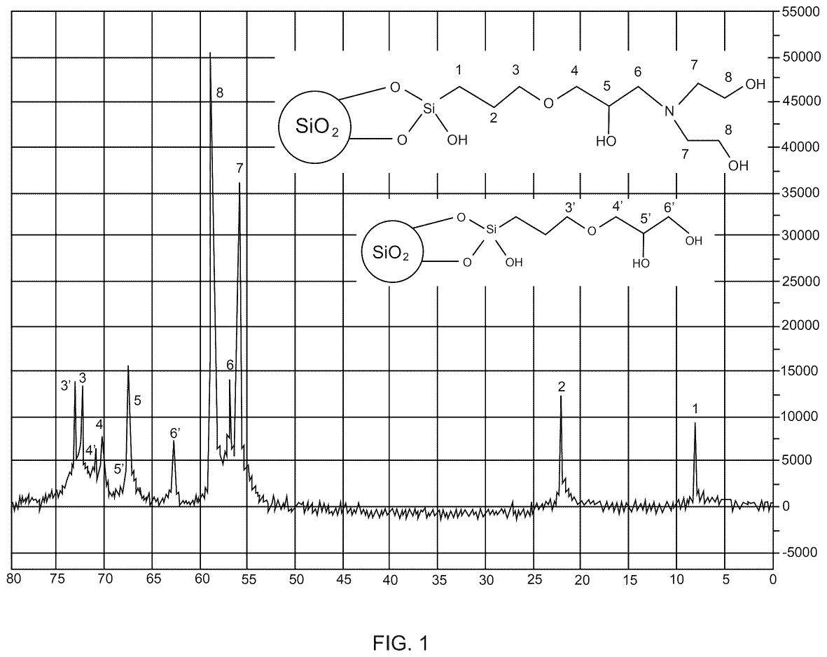

¹³C-NMR spectroscopic test was performed with this functionalized sample at approximately 10% solids (20% solids after ultrafiltration, and then diluted with equal volume of D20). As shown in FIG. 1, the signals showed the bonding of both the new silane carrying diethanolamine moiety as well as the diol function. Although not wish to be limited by the theory, the existing of both silane groups suggests incomplete reaction of diethanolamine with the glycidylsilane, or the glycidylsilane proceeds with partial hydrolysis (to give the diol group) upon reacting with diethanolamine.

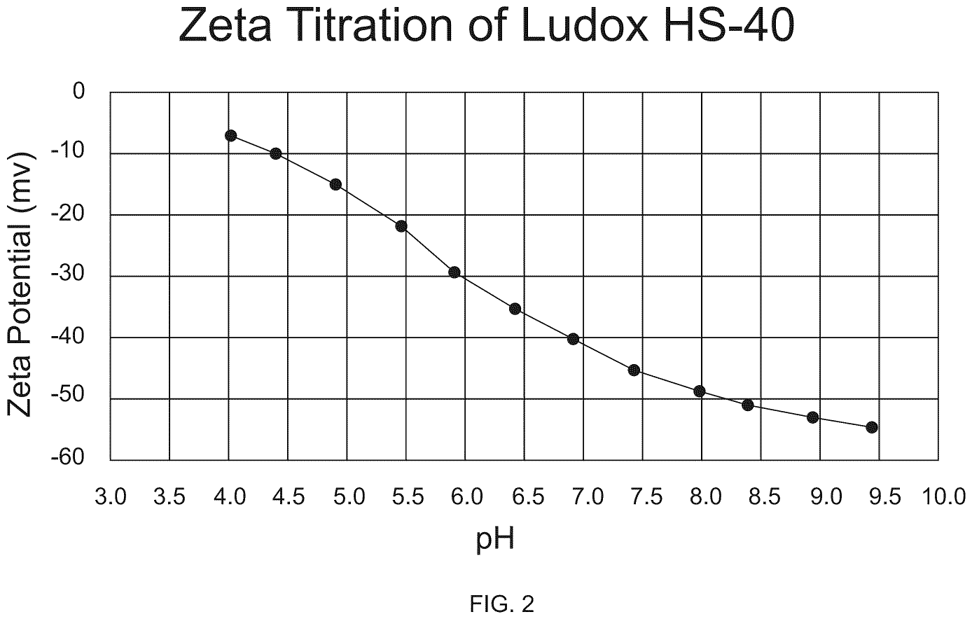

It is well-known that available colloidal silica as it is manufactured is almost always stabilized with sodium hydroxide (see “Colloidal Silica: Fundamentals and Applications”, Bergna and Roberts eds, Taylor & Francis, CRC Press 2006, p. 139) and carry negative charges at pH 7 due to deprotonation of the surface silanol groups. FIG. 2 shows the zeta potential at different pHs for LUDOX HS-40 (starting material for Example 1) which is a colloidal silica stabilized by NaOH.

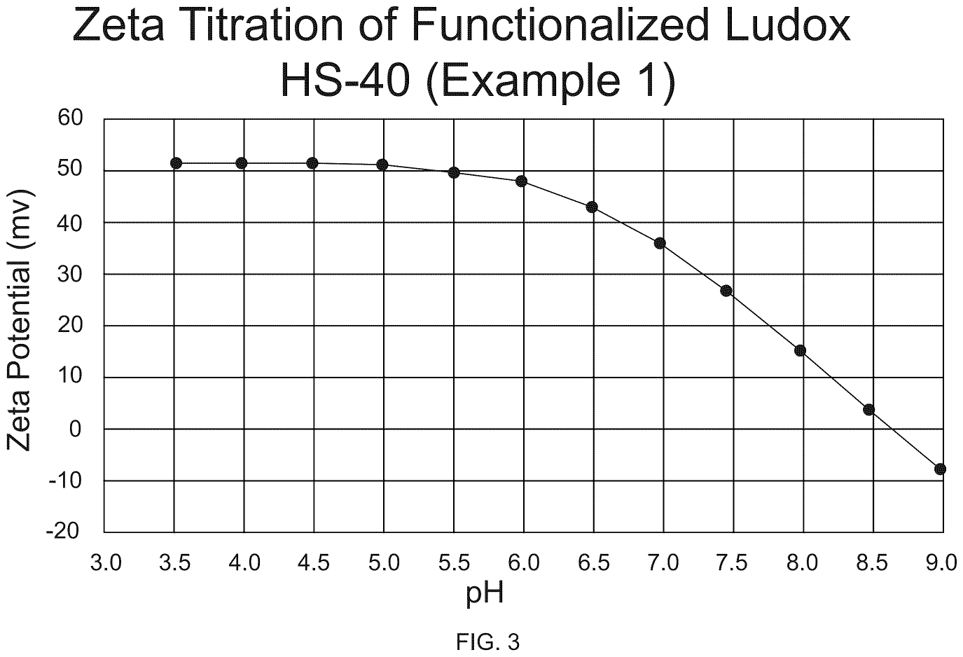

FIG. 3 depicts the zeta titration results of the Example 1 functionalized colloidal silica of the present technology. As shown, unlike the starting sample, LUDOX HS-40, which carries negative charges from pH 4 to pH 10, the particle surfaces carry positive charge for the functionalized sample when the aqueous colloidal system has the pH of below 8.5. Thus, the isoelectric point of the sample is around 8.5.

### Example 2 (DEA at 2.0 NM/nm² TL)

The same procedure as example 1 was followed except that the amounts of glycidylsilane and diethanol amine used were 3.47 g (14.6 mmol) and 1.54 g (14.6 mmol), respectively.

### Example 3 (DEA at 2.0 NM/Nm² TL, with that Methanol was Used as a Co-Solvent in the Silane Formation Reaction)

In a 50 ml beaker, 3.47 g (14.6 mmol) of glycidylsilane, 1.54 g (14.6 mmol) of DEA and 10 ml of methanol were mixed with a stir bar. A homogeneous solution was obtained from the beginning and the room temperature mixing was continued for one hour. After that, the methanol solution of the silane was added dropwise to 66.7 g of 30% colloidal silica (diluted HS-40). The mixture was stirred at room temperature for 1 hour, and then heated to 70° C. for another hour, and during the period, the majority of methanol was evaporated from the heating. Then the mixture was allowed to cool down to room temperature. The resulting mixture was purified by ultrafiltration with 5 volumes of DI water.

### Example 4 (TRIS Base at 1.7 NM/Nm² TL, with that Methanol was Used as a Co-Solvent)

In a 50 ml beaker, 2.95 g (12.5 mmol) of glycidylsilane, 1.51 g (12.5 mmol) of TRIS base (Tris(hydroxymethyl)aminomethane) and 20 ml of methanol were mixed with a stir bar. The mixture was heated to 55° C. in a water bath until a clear solution was formed. The structure of the newly formed silane is as follows:

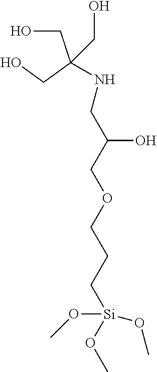 [SMILES: CO[Si](CCCOCC(O)CNC(CO)(CO)CO)(OC)OC]

After that, the methanol solution of the new silane was added dropwise to 66.7 g of 30% colloidal silica (diluted HS-40). The mixture was stirred at room temperature for 1 hour, and then heated to 70° C. for another hour and then the mixture was allowed to cool down to room temperature. The resulting mixture was purified by ultrafiltration with 5 volumes of DI water.

### Example 5 (DIPA, diisopropanolamine at 2.1 NM/nm² TL)

In a 20 ml vial, 3.64 g (15.4 mmol) of 3-glycidoxypropyltrimethoxysilane, 2.05 g (15.4 mmol) of diisopropanolamine (DIPA, or Bis(2-hydroxypropyl)amine) were mixed with a stir bar overnight to form a clear, single phased new silane. The structure of the newly formed silane is as follows:

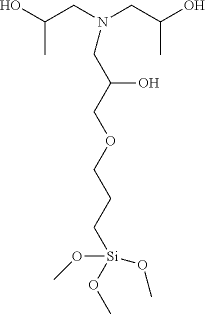 [SMILES: CO[Si](CCCOCC(O)CN(CC(C)O)CC(C)O)(OC)OC]

Then the new silane was added dropwise to 66.7 g of 30% colloidal silica (diluted HS-40). The mixture was stirred at room temperature for 1 hour, and then heated to 70° C. for another hour and then the mixture was allowed to cool down to room temperature. The resulting mixture was purified by ultrafiltration with 5 volumes of DI water.

### Example 6 (MEG, Meglumine at 1.7 NM/nm² TL)

In a 50 ml beaker, 2.95 g (12.5 mmol) of glycidylsilane, 2.43 g (12.5 mmol) of meglumine (MEG, or N-Methylglucamine) and 20 ml of methanol were mixed with a stir bar. The mixture was heated to 55° C. in a water bath until a clear solution was formed (2-3 hours). The structure of the newly formed silane is as follows:

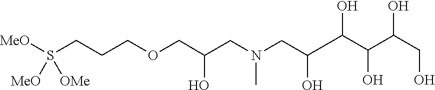 [SMILES: COS(CCCOCC(O)CN(C)CC(O)CC(O)C(O)C(O)CO)(OC)OC]

After the new silane was obtained, the methanol solution of the new silane was added dropwise to 66.7 g of 30% colloidal silica diluted (HS-40). The mixture was stirred at room temperature for 1 hour, and then heated to 70° C. for another hour and then the mixture was allowed to cool down to room temperature. The resulting mixture was purified by ultrafiltration with 5 volumes of DI water.

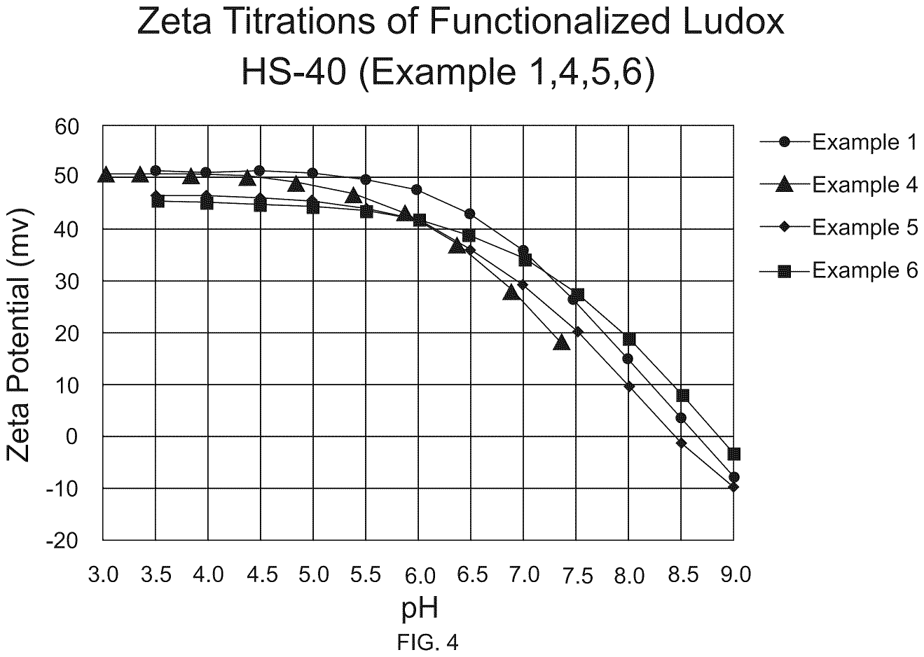

FIG. 4 depicts a comparison of particle surface zeta potentials of functionalized colloidal silica for different types of surface functional groups in the examples described above. As shown, similar pattern of positively charged surfaces vs. pHs were found with these types of surface groups.

### Example 7 (EAE, 2-(Ethylamino) ethanol at 2.5 NM/nm² TL)

The same procedure as example 1 for a new silane formation was followed except that the amounts of glycidylsilane and 2-(Ethylamino) ethanol used were 4.33 g (18.3 mmol) and 1.63 g (18.3 mmol), respectively. The newly formed silane has the structure as follows:

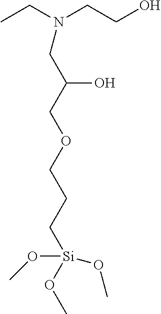 [SMILES: CCN(CCO)CC(O)COCCC[Si](OC)(OC)OC]

The reaction of this silane with 50 g of HS-40 was performed similarly as described for Example 1.

### Example 8 (BMEA, Bis(methoxyethyl)amine at 2.5 n/nm² TL)

The same procedure as Example 1 for a new silane formation was followed except that the amounts of glycidylsilane and bis(methoxyethyl)amine used were 4.33 g (18.3 mmol) and 2.44 g (18.3 mmol), respectively. The newly formed silane has the structure as follows:

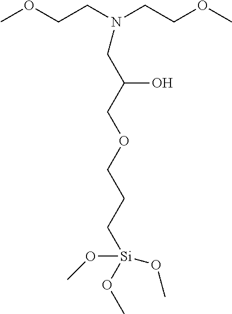

The reaction of this silane with 50 g of HS-40 was performed similarly as described for Example 1.

Table 2 lists the elemental analysis results from Examples 1-8.

TABLE 2

| | | | | | | G | H | I |
|---|---|---|---|---|---|---|---|---|
| | | C | | | | Theoretical | Calculated | Calculated |
| | | Targeted | | | | C % (based | bonded | bonded diol |
| | B | Treatment | D | E | F | on N % and | alkylamine | molecules |
| A | Amine | Level | C | H | N | the silane | density | density |
| Example | Type | (NM/nm²) | % | % | % | formula) | (molecules/nm²)^{a} | (NM/nm²)^{b} |
| 1 | DEA | 1.7 | 5.02 | 1.26 | 0.43 | 3.69 | 0.84 | 0.23 |
| 2 | DEA | 2.0 | 6.02 | 1.19 | 0.58 | 4.97 | 1.13 | 0.40 |
| 3 | DEA | 2.0 | 6.13 | 1.38 | 0.58 | 4.97 | 1.13 | 0.44 |
| 4 | TRIS | 1.7 | 5.05 | 1.08 | 0.46 | 3.99 | 0.91 | 0.40 |
| 5 | DIPA | 2.1 | 7.32 | 1.49 | 0.69 | 5.91 | 1.35 | 0.09 |
| 6 | MEG | 1.7 | 6.05 | 1.26 | 0.50 | 4.24 | 0.97 | 0.20 |
| 7 | EAE | 2.5 | 6.26 | 1.295 | 0.69 | 5.91 | 1.35 | 0.13 |
| 8 | BMEA | 2.5 | 6.50 | 1.40 | 0.52 | 5.30 | 1.01 | 0.46 |

^{a}Calculated based on nitrogen content of the dried samples.
^{b}Calculated based on net carbon content (total carbon subtracted from the theoretical carbon from the nitrogen content).

In Table 1, the found C, H, N values for the analyzed samples are reported in columns D, E, F. Based on the nitrogen numbers, one can calculate the density of the bonded alkylamine groups (column H). The corresponding “theoretical” carbons (column G), calculated from the nitrogen contents (column F) and based on the molecular formula of the bonded silane, seemed to be always smaller than the total carbon (column D) found. The differences are believed to be from the diol-silane groups from the hydrolysis of the epoxy group (without reacting with hydroxyalkylamine molecules), and the calculated diol-silane densities were listed in column I. These results were consistent with the findings from 13C-NMR data.

### Example 9 (DEA on LUDOX AM, 1.7 TL)

The same treating silane and procedures as Example 1 for functionalizing LUDOX AM, a 12 nm grade with colloidal silica functionalized with negatively charged aluminate. After the formation of the DEA silane, it was used to functionalize LUDOX AM at approximately 30% solids, and at around pH 9.

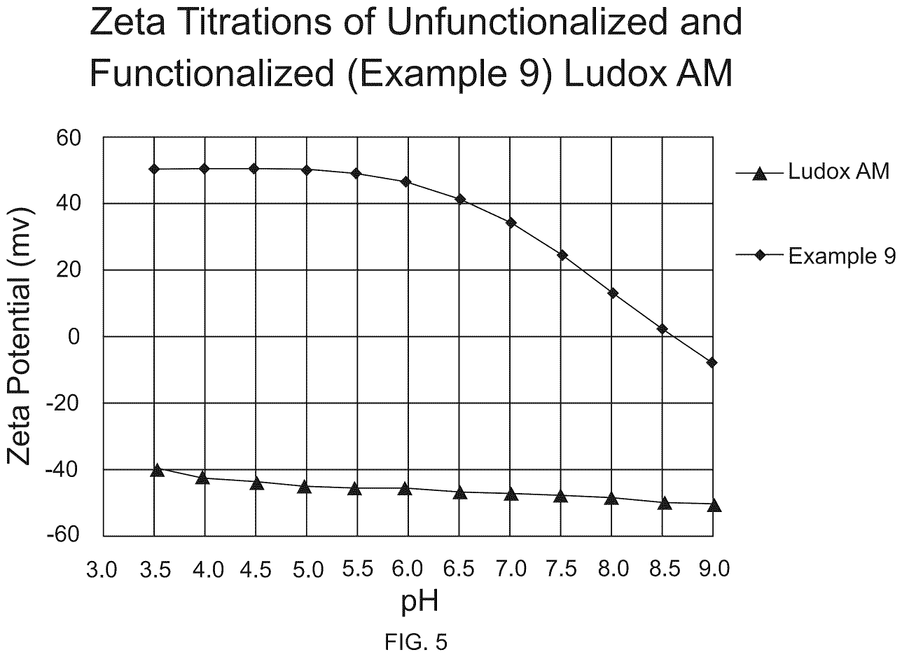

FIG. 5 compares the zeta potential profile of unmodified LUDOX AM and the bonded sample. As shown, the functionalization dramatically changed the zeta potentials of the colloidal particles so much from the starting material as it had similar profile to that of DEA silane functionalized HS-40, i.e., had positive charge at pH of less than 8.5.

### Example 10 (DEA on LUDOX SM, 2.5 TL)

In a 20 ml vial, 6.8 g (28.7 mmol) of 3-glycidoxypropyltrimethoxysilane and 3.83 g (28.7 mmol) of diethanolamine were reacted and a new silane was formed as described in Example 1. The newly formed silane was used to treat 66.6 g of LUDOX SM (30%, net 20 g of SiO₂, 7 nm particles, surface area of around 345 m²/g). After purification, a dried sample gave 13.77% carbon content.

### Example 11 (DEA on LUDOX TM-40, 1.7 TL)

The DEA silane formed by reacting 1.88 g (7.9 mmol) of glycidylsilane and 0.83 g (7.9 mmol) of diethanolamine was used to react with 50 g of 40% TM-40 (22 nm, surface area of around 140 m²/g) and 16.6 g of DI water.

### Example 12 (DEA on LUDOX PW-50 (X), 1.7 TL)

The DEA silane formed by reacting 1.0 g (4.2 mmol) of glycidylsilane and 0.45 g (4.2 mmol) of diethanolamine was used to react with 40 g of 50% PW-50X (mixed particle size grade with average particle of about 40 nm, surface area of around 75 m²/g) and 20 g of DI water.

### Example 13 (DEA on LUDOX CL, 1.7 TL)

The DEA silane was first formed by reacting 2.95 g (12.5 mmol) of glycidylsilane and 1.31 g (12.5 mmol) of DEA as described before. Then the new silane is dissolved in a mixture of 10 ml of water and 12.5 ml of 1M HCl (final pH of about 4.0), the silane solution was slowly added into stirred, 66.6 g of LUDOX CL (12 nm grade, positively charged with aluminum chlorohydrate). After mixing at room temperature for 1 hour and 70° C. for another 1 hour, the functionalized particles were purified by ultrafiltration with 5 volumes of DI water. The found carbon was 1.78% of a dried, purified sample, indicating lower amount of surface functional group that the similarly modified sample out of Example 1. This was probably due to the fact that most of the particle surfaces were covered with cationic aluminum ions.

### Comparative Example 1 (APS or 3-Aminopropylsilane, 1.7 TL)

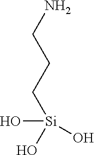

2.76 g (12.5 mmol) of aminopropyltrimethoxysilane was dissolved into 25 ml of 0.5 M HCl, with solution pH of 4.0. 50 g of LUDOX HS-40, diluted to 20% solids with 50 ml of DI water, was acidified to pH 4.0 with gradual addition of 1M HCl. To this dispersion was added the silane solution from APS silane solution. After the addition was complete, the mixture was stirred at room temperature for 1 hour and then heated to 70° C. for another hour. After cooling down to room temperature, the modified colloidal sample was purified by ultrafiltration with 5 volumes of DI water. Elemental analysis of carbon of the dried sample gave 1.27%.

### Comparative Example 2 (Sample Preparation According to a Prior Art Procedure)

U.S. Pat. No. 5,464,900 discloses a water soluble organosiloxane including an oligomer incorporating an addition product of at least two reactants wherein one reactant was at least one 3-glycidoxypropylalkoxy siloxane and the other reactant was at least one secondary hydroxyalkylamine, and with options of adding a colloidal silica into this mixture. U.S. Pat. No. 5,464,900 discloses the resulting mixture can be used for a coating composition and on coated films. A procedure similar to what was described in Examples 1 and 3 of U.S. Pat. No. 5,464,900 (at 1/10 scale) was performed to make the mixture containing both the silane and a colloidal silica.

Accordingly, 2.36 g of glycidylsilane, 1.05 g of DEA, and 0.5 g of isopropanol were placed in a flask and stirred rapidly at room temperature. Initially, the reaction was heterogenous, but after about 5-10 minutes, a clear, one phase viscous liquid was formed. After the mixture was stirred for about 30 minutes, the mixture was heated in a hot water bath for another 30 minutes at 45° C. After the mixture was removed from the hot water bath, the liquid was stirred for an additional 30 minutes, before adding 11 g of water to hydrolyze the methoxy groups. This would generate 20% solids of the coupling agent. 1 gram of LUDOX HS-30 (12 nm grade, 30% solids, similar product as that of NALCO 1030 on particle size and concentration) was diluted with 2 grams of DI water in a vial. This was mixed with 2 g of a 10% solution of the silane as just described, to provide a solution of 3:2 silica/oligomer. This mixture was tested for salt stability as described below.

### Comparative Example 3

In U.S. Pat. No. 6,015,843, it was disclosed a process for making silanized colloidal silica. In particular, bis(2-hydroxyethyl)-2-amino ethyltrimethoxysilane was listed although no preparation method was discussed. Despite this, bis(2-hydroxyethyl)-2-amino ethyltrimethoxysilane was prepared and utilized to generate a funcationalized colloidal silica to allow for comparison against Example 1.

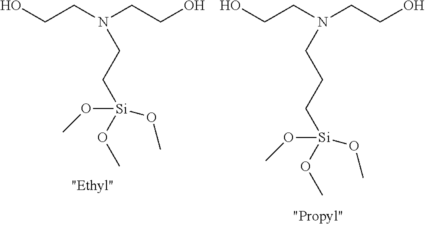

Thus, 3.62 g of 3-iodopropyltrimethoxysilane, 1.31 g of DEA, 1.26 g of triethylamine were mixed in 5 g of N,N-dimethylformamide at room temperature for 3 days. The mixture is then slowly added into 20 ml of 1M HCl (pH 1.0). 50 g of LUDOX HS-40, 16.6 g of DI water was acidified with 1M HCl to pH 2.0. The two were then mixed at room temperature for 30 minutes and then heated to 70° C. for 1 hour. After purification with ultrafiltration with 10 volumes of DI water, a functionalized colloidal was formed. A carbon content of 1.56% was obtained from dried sample by elemental analysis.

### Comparative Example 4

In U.S. Pat. No. 7,544,726, glycidylsilane functionalized colloidal silica was disclosed. The resulting surface functional group was determined as diol (from the hydrolysis of the epoxide of the glycidylsilane). A procedure similar to what was described in the Examples 1-8 as well as described in a literature report (Greenwood and Gevert, “Aqueous silica modified silica sols: theory and preparation”, Pigment & Resin Technology, 40/5 (2011) 275-284) was followed to make the Comparative Example 4.

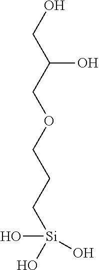 [SMILES: OCC(O)COCCC[Si](O)(O)O]

2.95 g of the glycidylsilane were mixed with 5 ml of DI water for 2 hours. A clear solution was formed after 2 hours. 50 g of HS-40 were diluted to 20% solids with 50 g of DI water. The stirred colloidal silica was heated to 60° C. with a water bath. To the colloidal silica was slowly added the aqueous silane solution over 1 hour. After the addition, the heating was continued for another 1 hour. After purification with 5 volumes of DI water, the corresponding functionalized colloidal silica was obtained. The C % content of a small, dried sample was determined to be 3.78%.

### Example 14 Salt Stability Test

It is well known that colloidal systems consisting of charged nanoparticles, stabilized by electrostatic repulsion forces, were sensitive to high ionic strength or high concentration salt solutions, due to significantly reduced Debye length in high salt environment. For example, a solution of NaCl in water at 25° C. and a concentration of 1×10⁻³ M has a Debye length of λ_{D}=9.6 nm, corresponding to roughly 40 water diameters; whereas at a concentration of 0.1 M the Debye length is λ_{D}=0.96 nm, equivalent to just four water diameters. Smith, Lee and Perkin, “The electrostatic screening length in concentrated electrolytes increases with concentration”. J. Phys. Chem. Lett. 2016, 7, 12, 2157-2163. Without intending to be bound by theory, it is believed that bonded surface organic groups on the colloidal particles may introduce a steric effect and help the salt tolerance of the colloidal systems comprising the functionalized colloidal nanoparticles. Here, we compared the colloidal stability with selected functions from the described examples against the starting material as well as Comparative Examples 1-4.

To standardized the salt concentrations in the stability test, we used the same ionic strengths of 0.5, 1.0, 2.0, and 3.0 with monovalent salt solution (NaCl), 2/1 bi-valent salt solutions (CaCl₂)) and 2/2 bi-valent salt solutions (MgSO₄). The molar ionic strength I is a function of the concentration of all ions present in that solution, and is defined as:

$$I = \frac{1}{2} * \sum ( Ci * {Zi}^{⋀} 2 )$$

where Ci is molar concentration of ion i, Zi is the charge number for the i, and the sum is taken over all ions (both cations and anions) in the solution. Accordingly, the molar concentrations of three different salt systems mentioned are:

| Ionic | NaCl | CaCl₂ | MgSO₄ |
|---|---|---|---|
| Strength | (M) | (M) | (M) |
| I = 0.5 | 0.5 | 0.17 | 0.12 |
| I = 1.0 | 1.0 | 0.32 | 0.24 |
| I = 2.0 | 2.0 | 0.65 | 0.50 |
| I = 3.0 | 3.0 | 1.0 | 0.74 |

The tests were carried out with that dilute colloidal samples were pH preadjusted to 4.0 (adjusted with either HCl or NaOH solutions) for all the colloidal samples and at 2% final colloidal silica concentrations. Thus, equal volumes of the salt solutions (with natural pH of 5-8, depending on the pH of the DI water used) in the table (2× concentrations than in the table) and 4% colloidal samples were mixed, and their colloidal stability was visually observed for 4 hours, 24 hours at room temperature (20° C.), at 40° C., and at 80° C. Arrhenius chemical reaction kinetics suggest that higher temperatures speed up reactions, often doubling the rate for every 10-degree rise. Thus, 24 hours at 40° C. (2×10 degrees) equal to approximately 24×2²=96 hours (or 4 days) at 20° C., and 24 hours at 80° C. (6×10 degrees) equal to approximately 24×2⁶=1536 hours (or 64 days) at 20° C.

Colloidal stability in the samples was determined by the visual observation of the results of the test samples in the experiments after aging at three different temperatures. The term “stable” means no visual or physical changes was observed in the colloidal dispersion after aging. The term “turbid” means that the colloidal dispersion became more whitish in color and less transparent but with no visible settlement observed in the samples. The term “settled” means that silica solids separated and settled to the bottom of the sample vial after aging. The term “gelled” means that the viscosity of the colloidal dispersion increased to the extent that the whole sample did not flow as a liquid.

Tables 3-10 provide a summary of the colloidal stability results of the test samples in these experiments:

TABLE 3

| 2% particles (pH 4.0) | | | | Stability | | | | | |
|---|---|---|---|---|---|---|---|---|---|
| in salt solution with | | | | RT | | 40° C. | | 80° C. | |
| NaCl | CaCl₂ | MgSO₄ | | 4 | 24 | 4 | 24 | 4 | 24 |
| (M) [symbol] | (M) [symbol] | (M) [symbol] | Silica | hrs | hrs | hrs | hrs | hrs | hrs |
| 0.5 | | | Ludox | stable | stable | stable | gelled | gelled | gelled |
| 1.0 | | | HS-40 | stable | stable | stable | gelled | gelled | gelled |
| 2.0 | | | | stable | stable | stable | gelled | gelled | gelled |
| 3.0 | | | | stable | gelled | gelled | gelled | gelled | gelled |
| | 0.17 | | | stable | stable | stable | gelled | gelled | gelled |
| | 0.32 | | | stable | stable | stable | gelled | gelled | gelled |
| | 0.65 | | | stable | stable | turbid | gelled | gelled | gelled |
| | 1.00 | | | stable | turbid | turbid | gelled | gelled | gelled |
| | | 0.12 | | stable | stable | stable | stable | gelled | gelled |
| | | 0.24 | | stable | stable | stable | stable | gelled | gelled |
| | | 0.50 | | stable | stable | stable | turbid | gelled | gelled |
| | | 0.74 | | stable | stable | stable | gelled | gelled | gelled |

TABLE 4

| 2% particles (pH 4.0) | | | | Stability | | | | | |
|---|---|---|---|---|---|---|---|---|---|
| in salt solution with | | | | RT | | 40° C. | | 80° C. | |
| NaCl | CaCl₂ | MgSO₄ | | 4 | 24 | 4 | 24 | 4 | 24 |
| (M) [symbol] | (M) [symbol] | (M) [symbol] | Silica | hrs | hrs | hrs | hrs | hrs | hrs |
| 0.5 | | | Example | stable | stable | stable | stable | stable | stable |
| 1.0 | | | 1 | stable | stable | stable | stable | stable | stable |
| 2.0 | | | | stable | stable | stable | stable | stable | stable |
| 3.0 | | | | stable | stable | stable | stable | stable | stable |
| | 0.17 | | | stable | stable | stable | stable | stable | stable |
| | 0.32 | | | stable | stable | stable | stable | stable | stable |
| | 0.65 | | | stable | stable | stable | stable | stable | stable |
| | 1.00 | | | stable | stable | stable | stable | stable | stable |
| | | 0.12 | | stable | stable | stable | stable | stable | stable |
| | | 0.24 | | stable | stable | stable | stable | stable | stable |
| | | 0.50 | | stable | stable | stable | stable | stable | stable |

TABLE 5

| 2% particles (pH 4.0) | | | | Stability | | | | | |
|---|---|---|---|---|---|---|---|---|---|
| in salt solution with | | | | RT | | 40° C. | | 80° C. | |
| NaCl | CaCl₂ | MgSO₄ | | 4 | 24 | 4 | 24 | 4 | 24 |
| (M) [symbol] | (M) [symbol] | (M) [symbol] | Silica | hrs | hrs | hrs | hrs | hrs | hrs |
| 0.5 | | | Example | stable | stable | stable | stable | stable | stable |
| 1.0 | | | 4 | stable | stable | stable | stable | stable | stable |
| 2.0 | | | | stable | stable | stable | stable | stable | stable |
| 3.0 | | | | stable | stable | stable | stable | stable | stable |
| | 0.17 | | | stable | stable | stable | stable | stable | stable |
| | 0.32 | | | stable | stable | stable | stable | stable | stable |
| | 0.65 | | | stable | stable | stable | stable | stable | stable |
| | 1.00 | | | stable | stable | stable | stable | stable | stable |
| | | 0.12 | | stable | stable | stable | stable | stable | stable |
| | | 0.24 | | stable | stable | stable | stable | stable | stable |
| | | 0.50 | | stable | stable | stable | stable | stable | stable |
| | | 0.74 | | stable | stable | stable | stable | stable | stable |

TABLE 6

| 2% particles (pH 4.0) | | | | Stability | | | | | |
|---|---|---|---|---|---|---|---|---|---|
| in salt solution with | | | | RT | | 40° C. | | 80° C. | |
| NaCl | CaCl₂ | MgSO₄ | | 4 | 24 | 4 | 24 | 4 | 24 |
| (M) [symbol] | (M) [symbol] | (M) [symbol] | Silica | hrs | hrs | hrs | hrs | hrs | hrs |
| 0.5 | | | Example | stable | stable | stable | stable | stable | stable |
| 1.0 | | | 6 | stable | stable | stable | stable | stable | stable |
| 2.0 | | | | stable | stable | stable | stable | stable | stable |
| 3.0 | | | | stable | stable | stable | stable | stable | stable |
| | 0.17 | | | stable | stable | stable | stable | stable | stable |
| | 0.32 | | | stable | stable | stable | stable | stable | stable |
| | 0.65 | | | stable | stable | stable | stable | stable | stable |
| | 1.00 | | | stable | stable | stable | stable | stable | stable |
| | | 0.12 | | stable | stable | stable | stable | stable | stable |
| | | 0.24 | | stable | stable | stable | stable | stable | stable |
| | | 0.50 | | stable | stable | stable | stable | stable | stable |
| | | 0.74 | | stable | stable | stable | stable | stable | stable |

TABLE 7

| 2% particles (pH 4.0) | | | | Stability | | | | | |
|---|---|---|---|---|---|---|---|---|---|
| in salt solution with | | | | RT | | 40° C. | | 80° C. | |
| NaCl | CaCl₂ | MgSO₄ | | 4 | 24 | 4 | 24 | 4 | 24 |
| (M) [symbol] | (M) [symbol] | (M) [symbol] | Silica | hrs | hrs | hrs | hrs | hrs | hrs |
| 0.5 | | | Comparative | stable | stable | stable | stable | gelled | gelled |
| 1.0 | | | Example 1 | stable | stable | stable | stable | gelled | gelled |
| 2.0 | | | | stable | stable | stable | stable | gelled | gelled |
| 3.0 | | | | stable | stable | stable | stable | gelled | gelled |
| | 0.17 | | | stable | stable | stable | stable | turbid | gelled |
| | 0.32 | | | stable | stable | stable | stable | gelled | gelled |
| | 0.65 | | | stable | stable | stable | stable | gelled | gelled |
| | 1.00 | | | stable | stable | stable | stable | gelled | gelled |
| | | 0.12 | | settled | settled | settled | settled | settled | settled |
| | | 0.24 | | turbid | settled | settled | settled | settled | settled |
| | | 0.50 | | stable | turbid | stable | settled | gelled | settled |
| | | 0.74 | | stable | stable | stable | settled | gelled | settled |

TABLE 8

| 2% particles (pH 4.0) in | | | | | |
|---|---|---|---|---|---|
| salt solution with | | | | Stability | |
| NaCl | CaCl₂ | MgSO₄ | | 80° C. | |
| (M) [symbol] | (M) [symbol] | (M) [symbol] | Silica | 4 hrs | 24 hrs |
| 0.5 | | | Comparative | stable | stable |
| 1.0 | | | Example 2 | settled | settled |
| 2.0 | | | | settled | settled |
| 3.0 | | | | settled | settled |
| | 0.65 | | | stable | stable |
| | 1 | | | stable | stable |
| | | 0.50 | | stable | stable |
| | | 0.74 | | stable | stable |

TABLE 9

| 2% particles (pH 4.0) | | | | Stability | | | | | |
|---|---|---|---|---|---|---|---|---|---|
| in salt solution with | | | | RT | | 40° C. | | 80° C. | |
| NaCl | CaCl₂ | MgSO₄ | | 4 | 24 | 4 | 24 | 4 | 24 |
| (M) [symbol] | (M) [symbol] | (M) [symbol] | Silica | hrs | hrs | hrs | hrs | hrs | hrs |
| 0.5 | | | Comparative | turbid | settled | turbid | settled | settled | settled |
| 1.0 | | | Example 3 | turbid | settled | turbid | settled | settled | settled |
| 2.0 | | | | turbid | settled | turbid | settled | settled | settled |
| 3.0 | | | | turbid | settled | turbid | settled | settled | settled |
| | 0.17 | | | settled | settled | settled | settled | settled | settled |
| | 0.32 | | | settled | settled | settled | settled | settled | settled |
| | 0.65 | | | settled | settled | settled | settled | settled | settled |
| | 1.00 | | | settled | settled | settled | settled | settled | settled |
| | | 0.12 | | turbid | settled | settled | settled | settled | settled |
| | | 0.24 | | turbid | settled | settled | settled | settled | settled |
| | | 0.50 | | turbid | settled | settled | settled | settled | settled |
| | | 0.74 | | turbid | settled | settled | settled | settled | settled |

TABLE 10

| 2% particles (pH 4.0) | | | | Stability | | | | | |
|---|---|---|---|---|---|---|---|---|---|
| in salt solution with | | | | RT | | 40° C. | | 80° C. | |
| NaCl | CaCl₂ | MgSO₄ | | 4 | 24 | 4 | 24 | 4 | 24 |
| (M) [symbol] | (M) [symbol] | (M) [symbol] | Silica | hrs | hrs | hrs | hrs | hrs | hrs |
| 0.5 | | | Comparative | stable | stable | stable | stable | stable | stable |
| 1.0 | | | Example 4 | stable | stable | stable | stable | stable | stable |
| 2.0 | | | | stable | stable | turbid | turbid | settled | settled |
| 3.0 | | | | settled | settled | settled | settled | settled | settled |
| | 0.17 | | | stable | stable | stable | stable | stable | stable |
| | 0.32 | | | stable | stable | stable | stable | stable | stable |
| | 0.65 | | | stable | stable | stable | stable | stable | stable |
| | 1.00 | | | stable | stable | stable | stable | settled | settled |
| | | 0.12 | | stable | stable | stable | stable | stable | stable |
| | | 0.24 | | stable | stable | stable | stable | stable | stable |
| | | 0.50 | | stable | stable | stable | stable | settled | settled |
| | | 0.74 | | settled | settled | settled | settled | settled | settled |

As shown Tables 3-10, Examples in accordance with the present technology (Examples 1, 4 and 6) demonstrate excellent stability and are significantly more stable than the HS-40 starting material as well as Comparative Examples 1-4.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified. Finally, it will be understood that disclosure of one of the foregoing terms also discloses embodiments using any of the other two terms or their equivalents.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present technology may include, but is not limited to, the features and combinations of features recited in the following lettered paragraphs, it being understood that the following paragraphs should not be interpreted as limiting the scope of the claims as appended hereto or mandating that all such features must necessarily be included in such claims:

A. A composition comprising water and a functionalized colloidal silica, wherein the functionalized colloidal silica comprises
silica particles comprising a surface, and
a structural unit according to Formula I and/or a structural unit according to

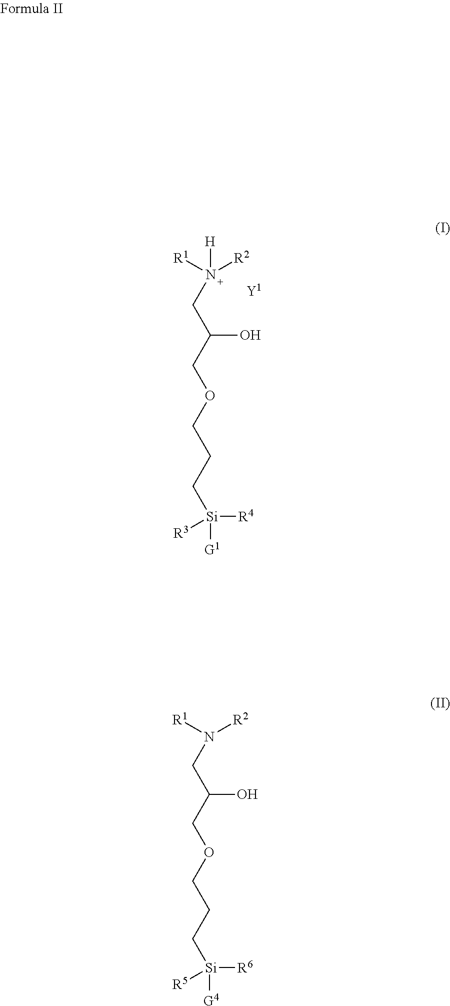

wherein
   R¹ is H, unsubstituted alkyl, a hydroxyl-substituted alkyl, an alkoxy-substituted alkyl, a hydroxyl-substituted cycloalkyl, aryl, or heteroaryl;
   R² is a hydroxyl-substituted alkyl, an alkoxy-substituted alkyl, or a hydroxyl-substituted cycloalkyl;
   or R¹ and R² taken together are a hydroxyl-substituted C₄-C₆ alkylene group;
   R³ is hydroxyl, alkoxy, aryloxy, or G²;
   R⁴ is hydroxyl, alkoxy, aryloxy, or G³;
   R⁵ is hydroxyl, alkoxy, aryloxy, or G⁵;
   R⁶ is hydroxyl, alkoxy, aryloxy, or G⁶;
   G¹, G², G³, G⁴, G⁵, and G⁶ are each independently an oxygen atom of the surface of the silica particle, where G¹, G², G³, G⁴, G⁵, and G⁶ are not the same oxygen atom; and
   Y¹ is an anion.

B. The composition of Paragraph A, wherein the composition comprises a pH of about 8.5 or lower.

C. The composition of Paragraph B, wherein the composition comprises a molar ratio of structural units according to Formula I to structural units according to Formula II of greater than 1:1.

D. The composition of any one of Paragraphs A-C, wherein a median diameter of the silica particles as determined by dynamic light scattering is about 1 nm to about 100 nm.

E. The composition of any one of Paragraphs A-D, wherein the silica particles have a Sears surface area of about 25 m²/g to about 1,200 m²/g.

F. The composition of any one of Paragraphs A-E, wherein the number of structural units according to Formula I and/or Formula II per nm² surface area is about 0.8 to about 3.5.

G. The composition of any one of Paragraphs A-F, wherein
R¹ is H, methyl, ethyl, a hydroxyl-substituted C₂-C₆ alkyl, or an alkoxy-substituted C₂-C₆ alkyl;
R² is a hydroxyl-substituted C₂-C₆ alkyl or an alkoxy-substituted C₂-C₆ alkyl;
or R¹ and R² taken together are a hydroxyl-substituted C₄-C₆ alkylene group.

H. The composition of any one of Paragraphs A-G, wherein R³ is G².

I. The composition of any one of Paragraphs A-H, wherein R⁴ is hydroxyl.

J. The composition of any one of Paragraphs A-I, wherein the silica particles comprise at least one structural unit according to Formula Ia, Ib, Ic, Id, Ie, If, or Ig

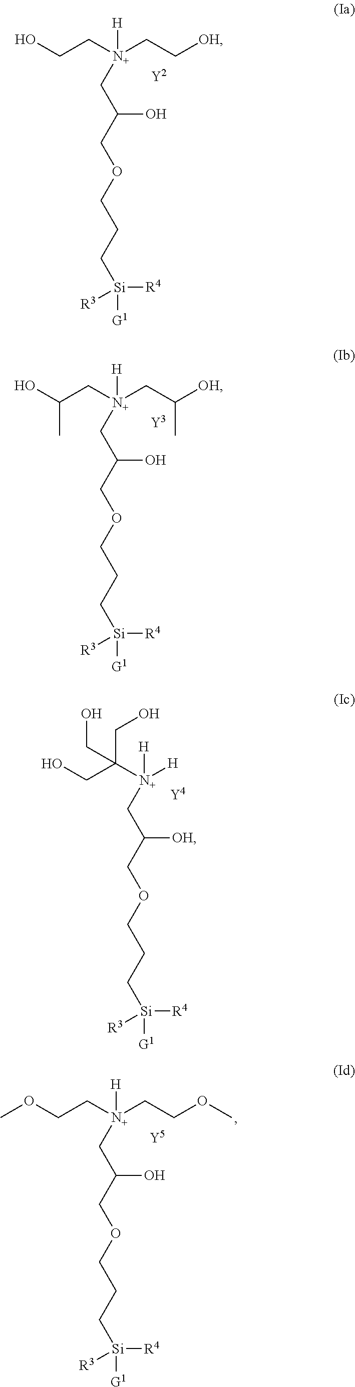

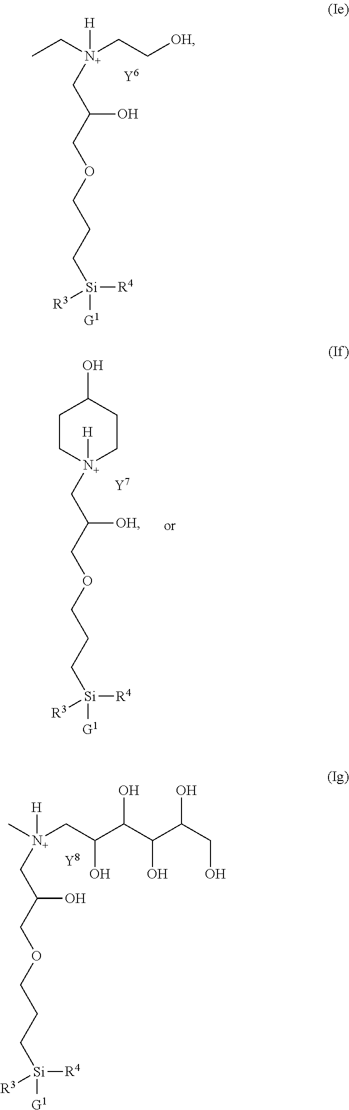

where Y², Y³, Y⁴, Y⁵, Y⁶, Y⁷, and Y⁸ are independently at each occurrence an anion.

K. The composition of any one of Paragraphs A-J, wherein the silica particles further comprise at least one structural unit according to Formula III

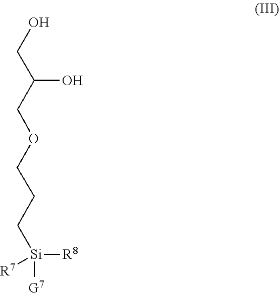

wherein
   R⁷ is hydroxyl, alkoxy, aryloxy, or G⁸;
   R⁸ is hydroxyl, alkoxy, aryloxy, or G⁹;
   G⁷, G⁸, and Go are each independently an oxygen atom of the surface of the silica particle, where G⁷, G⁸, and Go are not the same oxygen atom.

L. The composition of any one of Paragraphs A-K, wherein the composition comprises about 0.1 wt % to about 50 wt % of the functionalized colloidal silica.

M. The composition of any one of Paragraphs A-L, wherein the composition is stable to aging for 24 hours or longer at temperature of 80° C. when the composition comprises a salt solution at an ionic strength of 0.5 to 3.0.

N. A method of making a functionalized colloidal silica, the method comprising contacting a colloidal silica with a silane according to Formula IV to yield the functionalized colloidal silica

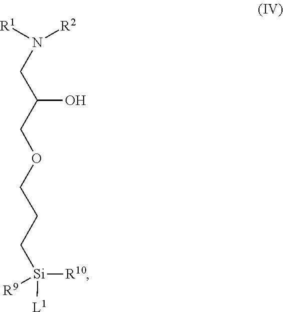

wherein
   R¹ is H, unsubstituted alkyl, a hydroxyl-substituted alkyl, an alkoxy-substituted alkyl, a hydroxyl-substituted cycloalkyl, aryl, or heteroaryl;
   R² is a hydroxyl-substituted alkyl, an alkoxy-substituted alkyl, or a hydroxyl-substituted cycoalkyl;
   or R¹ and R² taken together are a hydroxyl-substituted C₄-C₆ alkylene group;
   R⁹ is hydroxyl, alkoxy, or aryloxy;
   R¹⁰ is hydroxyl, alkoxy, or aryloxy; and
   L¹ is alkoxy or aryloxy.

O. The method of Paragraph N, wherein R⁷, R⁸, and L¹ are each independently alkoxy or aryloxy.

P. The method of Paragraph N or Paragraph O, wherein R⁷, R⁸, and L¹ are each independently alkoxy or aryloxy.

Q. The method of any one of Paragraphs N-P, wherein the functionalized colloidal silica comprises a surface and a structural unit according to Formula I and/or a structural unit according to Formula II

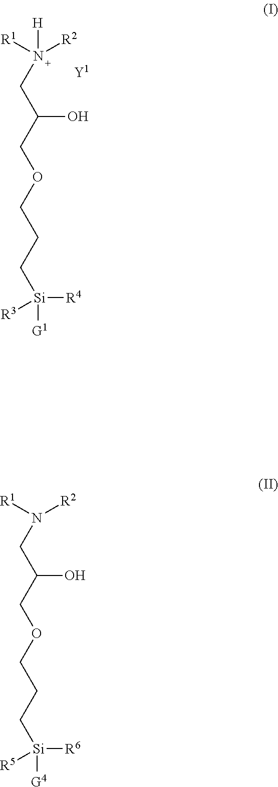

wherein
   R³ is hydroxyl, alkoxy, aryloxy, or G²;
   R⁴ is hydroxyl, alkoxy, aryloxy, or G³;
   R⁵ is hydroxyl, alkoxy, aryloxy, or G⁵;
   R⁶ is hydroxyl, alkoxy, aryloxy, or G⁶;
   G¹, G², G³, G⁴, G⁵, and G⁶ are each independently an oxygen atom of the surface of the silica particle, where G¹, G², G³, G⁴, G⁵, and G⁶ are not the same oxygen atom; and
   Y¹ is an anion.

R. The method of any one of Paragraphs N-Q, wherein the method comprises contacting the colloidal silica with the silane in a medium comprising a polar organic solvent.

S. The method of Paragraph R, wherein the polar organic solvent comprises methanol, ethanol, propanol, ethylene glycol, acetone, dimethylformamide, N-methylpyrrolidone, or a combination of any two or more thereof.

T. The method of any one of Paragraphs N-S, wherein the method comprises contacting about 1.5 to about 3.0 molecules silane per 1 nm² colloidal silica surface area.

U. The method of any one of Paragraphs N-T, wherein the method comprises
contacting the colloidal silica with the silane to yield an initial mixture, the initial mixture comprising the functionalized colloidal silica and one or more of unreacted silane, a silane not bonded to colloidal silica, or an impurity; and
purifying the functionalized colloidal silica by ultrafiltration of the initial mixture.

V. The method of any one of Paragraphs N-U, wherein the method provides a composition comprising water and the functionalized colloidal silica.

W. The method of Paragraph V, wherein the composition is stable to aging for 24 hours or longer at temperature of 80° C. when the composition comprises a salt solution at an ionic strength of 0.5 to 3.0.

X. The method of any one of Paragraphs N-W, wherein the method provides a composition according to any one of Paragraphs A-M.

Y. A functionalized silica prepared according to a method of any one of Paragraphs N-W.

Other embodiments are set forth in the following claims.

What is claimed:

1. A composition comprising water and a functionalized colloidal silica, wherein the functionalized colloidal silica comprises
silica particles comprising a surface, and
a structural unit according to Formula I and/or a structural unit according to Formula II 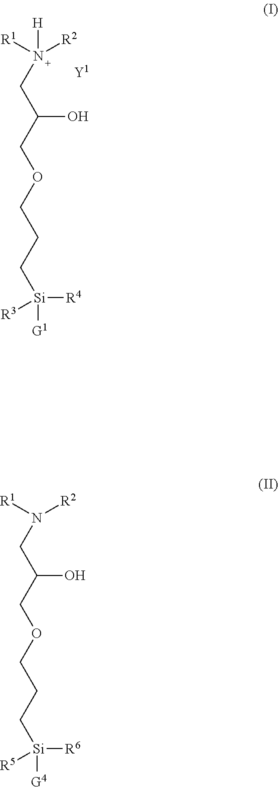
wherein
R¹ is H, unsubstituted alkyl, a hydroxyl-substituted alkyl, an alkoxy-substituted alkyl, a hydroxyl-substituted cycloalkyl, aryl, or heteroaryl;
R² is a hydroxyl-substituted alkyl, an alkoxy-substituted alkyl, or a hydroxyl-substituted cycloalkyl;
or R¹ and R² taken together are a hydroxyl-substituted C₄-C₆ alkylene group;
R³ is hydroxyl, alkoxy, aryloxy, or G²;
R⁴ is hydroxyl, alkoxy, aryloxy, or G³;
R⁵ is hydroxyl, alkoxy, aryloxy, or G⁵;
R⁶ is hydroxyl, alkoxy, aryloxy, or G⁶;
G¹, G², G³, G⁴, G⁵, and G⁶ are each independently an oxygen atom of the surface of the silica particle, where G¹, G², G³, G⁴, G⁵, and G⁶ are not the same oxygen atom; and
Y¹ is an anion.

2. The composition of claim 1, wherein the composition comprises a pH of about 8.5 or lower.

3. The composition of claim 2, wherein the composition comprises a molar ratio of structural units according to Formula I to structural units according to Formula II of greater than 1:1.

4. The composition of claim 1, wherein a median diameter of the silica particles, as determined by dynamic light scattering, is about 1 nm to about 100 nm.

5. The composition of claim 1, wherein the silica particles have a Sears surface area of about 25 m²/g to about 1,200 m²/g.

6. The composition of claim 1, wherein the number of structural units according to Formula I and/or Formula II per nm² surface area is about 0.8 to about 3.5.

7. The composition of claim 1, wherein
R¹ is H, methyl, ethyl, a hydroxyl-substituted C₂-C₆ alkyl, or an alkoxy-substituted C₂-C₆ alkyl;
R² is a hydroxyl-substituted C₂-C₆ alkyl or an alkoxy-substituted C₂-C₆ alkyl;
or R¹ and R² taken together are a hydroxyl-substituted C₄-C₆ alkylene group.

8. The composition of claim 1, wherein R³ is G².

9. The composition of claim 1, wherein R⁴ is hydroxyl.

10. The composition of claim 1, wherein the silica particles comprise at least one structural unit according to Formula Ia, Ib, Ic, Id, Ie, If, or Ig 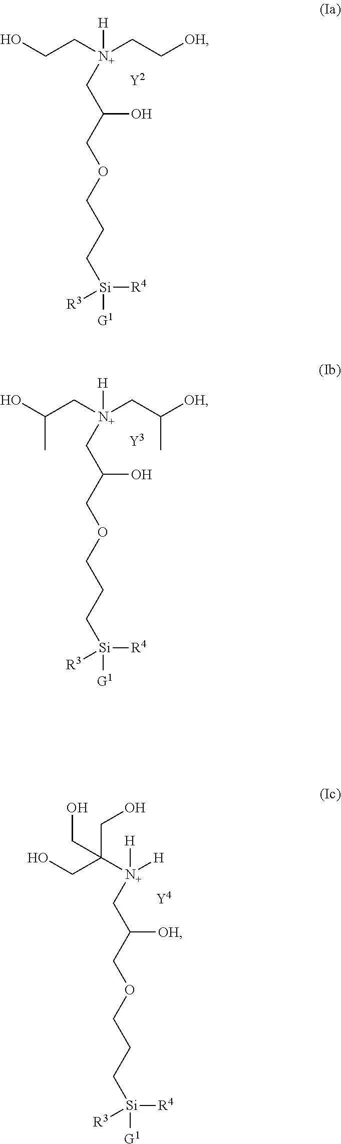 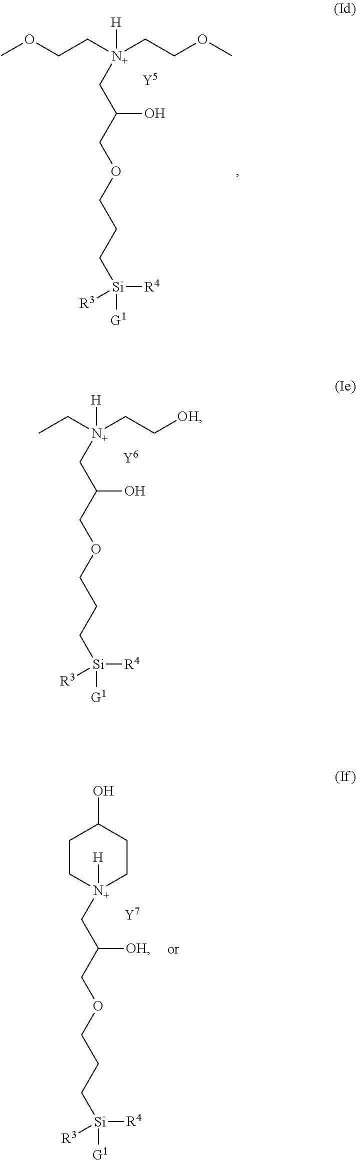 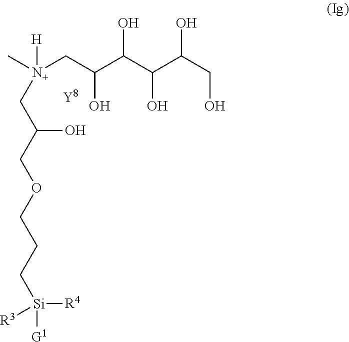
where Y², Y³, Y⁴, Y⁵, Y⁶, Y⁷, and Y⁸ are independently at each occurrence an anion.

11. The composition of claim 1, wherein the silica particles further comprise at least one structural unit according to Formula III 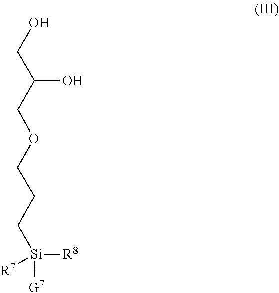
wherein
R⁷ is hydroxyl, alkoxy, aryloxy, or G⁸;
R⁸ is hydroxyl, alkoxy, aryloxy, or G⁹;
G⁷, G⁸, and G⁹ are each independently an oxygen atom of the surface of the silica particle, where G⁷, G⁸, and G⁹ are not the same oxygen atom.

12. The composition of claim 1, wherein the composition comprises about 0.1 wt % to about 50 wt % of the functionalized colloidal silica.

13. The composition of claim 1, wherein the composition is stable to aging for 24 hours or longer at temperature of 80° C. when the composition comprises a salt solution at an ionic strength of 0.5 to 3.0.

14. A method of making a functionalized colloidal silica, the method comprising contacting a colloidal silica with a silane according to Formula IV to yield the functionalized colloidal silica 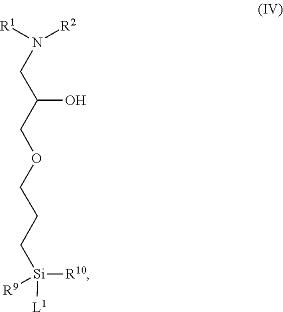
wherein
R¹ is H, unsubstituted alkyl, a hydroxyl-substituted alkyl, an alkoxy-substituted alkyl, a hydroxyl-substituted cycloalkyl, aryl, or heteroaryl;
R² is a hydroxyl-substituted alkyl, an alkoxy-substituted alkyl, or a hydroxyl-substituted cycoalkyl;
or R¹ and R² taken together are a hydroxyl-substituted C₄-C₆ alkylene group;
R⁹ is hydroxyl, alkoxy, or aryloxy;
R¹⁰ is hydroxyl, alkoxy, or aryloxy; and
L¹ is alkoxy or aryloxy.

15. The method of claim 14, wherein R⁷, R⁸, and L¹ are each independently alkoxy or aryloxy.

16. (canceled)

17. The method of claim 14, wherein the functionalized colloidal silica comprises a surface and a structural unit according to Formula I and/or a structural unit according to Formula II 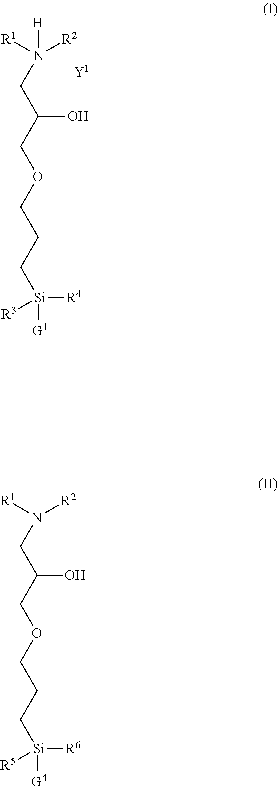
wherein
R³ is hydroxyl, alkoxy, aryloxy, or G²;
R⁴ is hydroxyl, alkoxy, aryloxy, or G³;
R⁵ is hydroxyl, alkoxy, aryloxy, or G⁵;
R⁶ is hydroxyl, alkoxy, aryloxy, or G⁶;
G¹, G², G³, G⁴, G⁵, and G⁶ are each independently an oxygen atom of the surface of the silica particle, where G¹, G², G³, G⁴, G⁵, and G⁶ are not the same oxygen atom; and
Y¹ is an anion.

18. The method of claim 14, wherein the method comprises contacting the colloidal silica with the silane in a medium comprising a polar organic solvent, and wherein the polar organic solvent comprises methanol, ethanol, propanol, ethylene glycol, acetone, dimethylformamide, N-methylpyrrolidone, or a combination of any two or mor thereof.

19. (canceled)

20. The method of claim 14, wherein the method comprises contacting about 1.5 to about 3.0 molecules silane per 1 nm² colloidal silica surface area.

21. The method of claim 14, wherein the method comprises
contacting the colloidal silica with the silane to yield an initial mixture, the initial mixture comprising the functionalized colloidal silica and one or more of unreacted silane, a silane not bonded to colloidal silica, or an impurity; and
purifying the functionalized colloidal silica by ultrafiltration of the initial mixture.

22. (canceled)

23. (canceled)

24. (canceled)

25. A functionalized silica prepared according to the method of claim 14.
